(19) United States
(12) Patent Application Publication
(10) Pub. No.: US 2019/0005502 A1
(43) Pub. Date: Jan. 3, 2019

(54) METHOD, SYSTEM, AND COMPUTER PROGRAM PRODUCT FOR SEGMENTING GEOGRAPHIC CODES IN A BEHAVIOR MONITORED SYSTEM INCLUDING A PLURALITY OF ACCOUNTS

(71) Applicant: Visa International Service Association, San Francisco, CA (US)

(72) Inventors: Debesh Kumar, San Mateo, CA (US); Guangyu Wang, Danville, CA (US); Lawson Lau, Palo Alto, CA (US); Xie Xie, Sunnyvale, CA (US)

(21) Appl. No.: 15/637,355

(22) Filed: Jun. 29, 2017

(51) Int. Cl. G06Q 20/40; G06Q 30/02

(52) U.S. Cl. CPC G06Q 20/4016; G06Q 30/0201; G06Q 30/0205

(57) ABSTRACT

A method, system, and apparatus for segmenting geographic codes in a behavior-monitored system including a plurality of accounts includes: identifying a plurality of geographic codes associated with the plurality of accounts, wherein each account is associated with a geographic code; receiving geographic transaction metrics associated with each geographic code; determining an optimal number of segments into which the plurality of geographic codes is to be segmented based at least partially on the geographic transaction metrics; segmenting the plurality of geographic codes into the optimal number of segments based at least partially on the geographic transaction metrics, such that each segment is associated with segment transaction metrics; and automatically implementing a target action with respect to at least one account of the plurality of accounts based at least partially on the segment transaction metrics corresponding to at least one segment of the optimal number of segments.

### BACKGROUND OF THE INVENTION

### Field of the Invention

This invention relates generally to determining geographic areas based on transaction characteristics and, in some non-limiting embodiments or aspects, to a method, system, and computer program product for segmenting geographic codes in a behavior monitored system including a plurality of accounts.

### Description of Related Art

Accounts for portable financial devices, such as credit cards, debit cards, or electronic wallet applications, are associated with geographic designations or codes, such as United States (U.S.) zip codes, Metropolitan Statistical Areas (MSA), Core-based Statistical Areas (CBSA), Designated Market Areas (DMA), and/or U.S. states, which may indicate a location of the residence of a user of the account, such as a U.S. zip code of the billing address associated with the account, and/or a geographic location of a financial transaction conducted with a portable financial device of the account, such as a U.S. zip code of a merchant at which the financial transaction is conducted.

These existing geographic designations or codes are based on geographic boundaries, not the transactional behavior of the accounts, and can be too granular or high level for specific use cases. For example, analytics and data products based on existing geographic designations or codes are limited in their ability to identify or classify users of accounts by these geographic boundaries that do not take into account transactional behavior, such as purchase or spend behavior.

Therefore, there is a need in the art for portable financial device issuing institutions, transaction service providers, and merchant banks to be able to monitor and analyze transactional instances with respect to geographic designations or codes in a manner that takes into account transaction behavior, including purchase or spend behavior of the accounts associated with the geographic designations or codes, so as to be able to more efficiently determine users of accounts more likely to be receptive to specific messages and incentives regarding use or increased use of their portable financial devices, detect fraudulent activity in financial transactions of the accounts, and/or provide geographic benchmarking of specific locations.

### SUMMARY OF THE INVENTION

Accordingly, provided is an improved method, system, and computer program product for segmenting geographic codes in a behavior-monitored system including a plurality of accounts.

According to a non-limiting embodiment or aspect, provided is a computer-implemented method for segmenting geographic codes in a behavior-monitored system including a plurality of accounts, comprising: identifying, with at least one processor, a plurality of geographic codes associated with the plurality of accounts, wherein each account of the plurality of accounts is associated with a geographic code of the plurality of geographic codes; receiving, with at least one processor, geographic transaction metrics associated with each geographic code of the plurality of geographic codes; determining, with at least one processor, an optimal number of segments into which the plurality of geographic codes is to be segmented based at least partially on the geographic transaction metrics; segmenting, with at least one processor, the plurality of geographic codes into the optimal number of segments based at least partially on the geographic transaction metrics, such that each segment is associated with segment transaction metrics; and automatically implementing, with at least one processor, a target action with respect to at least one account of the plurality of accounts based at least partially on the segment transaction metrics corresponding to at least one segment of the optimal number of segments.

In one non-limiting embodiment or aspect, the geographic transaction metrics define, for each geographic code of the plurality of geographic codes, proportions of transactions in a plurality of categories by a subset of accounts of the plurality of accounts associated with that geographic code.

In one non-limiting embodiment or aspect, the plurality of categories comprises at least two of the following: travel and entertainment transactions, retail transactions, dining transactions, everyday spending transactions, or any combination thereof.

In one non-limiting embodiment or aspect, the segment transaction metrics define, for each segment of the optimal number of segments, proportions of transactions in a plurality of categories by a subset of accounts of the plurality of accounts associated with that segment.

In one non-limiting embodiment or aspect, the computer-implemented method further comprises analyzing, with at least one processor, proportions of transactions in the plurality of categories by the at least one account of the plurality of accounts with respect to the segment transaction metrics of the at least one segment of the number of segments.

In one non-limiting embodiment or aspect, the at least one segment of the optimal number of segments includes a geographic code associated with the at least one account.

In one non-limiting embodiment or aspect, the at least one segment of the optimal number of segments does not include a geographic code associated with the at least one account.

In one non-limiting embodiment or aspect, the at least one segment comprises a plurality of segments of the optimal number of segments.

In one non-limiting embodiment or aspect, the analyzing comprises monitoring the proportions of transactions in the plurality of categories by the at least one account with respect to the segment transaction metrics of the at least one segment of the optimal number of segments to detect fraudulent activity in the transactions of the at least one account, and wherein the target action comprises automatically suspending, with at least one processor and in response to detecting the fraudulent activity, at least one of a transaction activity of the at least one account and access of the at least one account to a system.

In one non-limiting embodiment or aspect, the at least one account comprises multiple accounts associated with transactions with a particular merchant, and wherein the analyzing comprises comparing a percentage of the proportions of the plurality of transactions in the plurality of categories by the multiple accounts that are associated with the particular merchant to the segment transaction metrics of the at least one segment of the optimal number of segments.

In one non-limiting embodiment or aspect, the target action comprises automatically enrolling, with at least one processor, the at least one account in an incentive program.

In one non-limiting embodiment or aspect, the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

In one non-limiting embodiment or aspect, the computer-implemented method further comprises normalizing, with at least one processor, the plurality of geographic transaction metrics to a unified scale.

In one non-limiting embodiment or aspect, the unified scale is determined according to the following equation: VS=(VO−MM)/MSD, wherein VS is the scaled value of a geographic transaction metric, VO is the original, unscaled value of the geographic transaction metric, MM is the mean of all values of the geographic transaction metrics, and MSD is the standard deviation of the geographic transaction metric.

In one non-limiting embodiment or aspect, segmenting the plurality of geographic codes into the optimal number of segments of the plurality of geographic codes comprises applying, with at least one processor, at least one of the following algorithms: k-means clustering, hierarchical clustering, a neural network, a decision tree, or any combination thereof, to the plurality of geographic transaction metrics associated with the plurality of geographic codes.

In one non-limiting embodiment or aspect, segmenting the plurality of geographic codes into the optimal number of segments of the plurality of geographic codes comprises applying, with at least one processor, k-means clustering, the method further comprising: determining centroids of the optimal number of segments; and iterating between a data assignment step and a centroid update step until a stopping criteria is met, wherein the data assignment step comprises: assigning each geographic code to a segment of the optimal number of segments according to the following equation:

$${arg min}_{{c}_{i} ∈ C} {dist ( {c}_{i} , x )}^{2}$$

wherein i is the optimal number of segments, C is a set of centroids cᵢ including the centroids of the optimal number of segments, x is a geographic code of the plurality of geographic codes, and dist(·) is the standard (L2) Euclidean distance between the geographic code x and the centroids cᵢ; wherein the centroid update step comprises: recalculating the centroids of the optimal number of segments according to the following equation:

$${c}_{i} = \frac{1}{\vert {S}_{i} \vert} {\sum }_{{x}_{i} ∈ {S}_{i}} {x}_{i}$$

wherein Sᵢ is set of geographic code assignments for each i^{th} segment centroid.

According to a non-limiting embodiment or aspect, provided is a system for segmenting geographic codes in a behavior-monitored system including a plurality of accounts, comprising at least one server computer including at least one processor, the at least one server computer programmed and/or configured to: identify a plurality of geographic codes associated with the plurality of accounts, wherein each account of the plurality of accounts is associated with a geographic code of the plurality of geographic codes; receive geographic transaction metrics associated with each geographic code of the plurality of geographic codes; determine an optimal number of segments into which the plurality of geographic codes is to be segmented based at least partially on the geographic transaction metrics; segment the plurality of geographic codes into the optimal number of segments based at least partially on the geographic transaction metrics, such that each segment is associated with segment transaction metrics; and automatically implement a target action with respect to at least one account of the plurality of accounts based at least partially on the segment transaction metrics corresponding to at least one segment of the optimal number of segments.

In one non-limiting embodiment or aspect, the geographic transaction metrics define, for each geographic code of the plurality of geographic codes, proportions of transactions in a plurality of categories by a subset of accounts of the plurality of accounts associated with that geographic code.

In one non-limiting embodiment or aspect, the plurality of categories comprises at least two of the following: travel and entertainment transactions, retail transactions, dining transactions, everyday spending transactions, or any combination thereof.

In one non-limiting embodiment or aspect, the segment transaction metrics define, for each segment of the optimal number of segments, proportions of transactions in a plurality of categories by a subset of accounts of the plurality of accounts associated with that segment.

In one non-limiting embodiment or aspect, the at least one server computer is programmed and/or configured to: analyze proportions of transactions in the plurality of categories by the at least one account of the plurality of accounts with respect to the segment transaction metrics of the at least one segment of the number of segments.

In one non-limiting embodiment or aspect, the at least one segment of the optimal number of segments includes a geographic code associated with the at least one account.

In one non-limiting embodiment or aspect, the at least one segment of the optimal number of segments does not include a geographic code associated with the at least one account.

In one non-limiting embodiment or aspect, the at least one segment comprises a plurality of segments of the optimal number of segments.

In one non-limiting embodiment or aspect, the at least one server computer is programmed and/or configured to: monitor the proportions of transactions in the plurality of categories by the at least one account with respect to the segment transaction metrics of the at least one segment of the optimal number of segments to detect fraudulent activity in the transactions of the at least one account; and automatically implement the target action by automatically suspending, in response to detecting the fraudulent activity, at least one of a transaction activity of the at least one account and access of the at least one account to a system.

In one non-limiting embodiment or aspect, the at least one account comprises multiple accounts associated with transactions with a particular merchant, and wherein the at least one server computer is programmed and/or configured to: compare a percentage of the proportions of the plurality of transactions in the plurality of categories by the multiple accounts that are associated with the particular merchant to the segment transaction metrics of the at least one segment of the optimal number of segments.

In one non-limiting embodiment or aspect, the at least one server computer is programmed and/or configured to: automatically implement the target action by automatically enrolling the at least one account in an incentive program.

In one non-limiting embodiment or aspect, the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

In one non-limiting embodiment or aspect, the at least one server computer is programmed and/or configured to: normalize the plurality of geographic transaction metrics to a unified scale.

In one non-limiting embodiment or aspect, the unified scale is determined according to the following equation: VS=(VO−MM)/MSD, wherein VS is the scaled value of a geographic transaction metric, VO is the original, unscaled value of the geographic transaction metric, MM is the mean of all values of the geographic transaction metrics, and MSD is the standard deviation of the geographic transaction metric.

In one non-limiting embodiment or aspect, the at least one server computer is programmed and/or configured to segment the plurality of geographic codes into the optimal number of segments of the plurality of geographic codes by applying at least one of the following algorithms: k-means clustering, hierarchical clustering, a neural network, a decision tree, or any combination thereof, to the plurality of geographic transaction metrics associated with the plurality of geographic codes.

In one non-limiting embodiment or aspect, the at least one server computer is programmed and/or configured to segment the plurality of geographic codes into the optimal number of segments by applying k-means clustering, wherein the at least one server computer is programmed and/or configured to: determine centroids of the optimal number of segments; and iterate between a data assignment step and a centroid update step until a stopping criteria is met, wherein the data assignment step comprises: assigning each geographic code to a segment of the optimal number of segments according to the following equation:

$${arg min}_{{c}_{i} ∈ C} {dist ( {c}_{i} , x )}^{2}$$

wherein i is the optimal number of segments, C is a set of centroids cᵢ including the centroids of the optimal number of segments, x is a geographic code of the plurality of geographic codes, and dist(·) is the standard (L2) Euclidean distance between the geographic code x and the centroids cᵢ; wherein the centroid update step comprises: recalculating the centroids of the optimal number of segments according to the following equation:

$${c}_{i} = \frac{1}{\vert {S}_{i} \vert} {\sum }_{{x}_{i} ∈ {S}_{i}} {x}_{i}$$

wherein Sᵢ is set of geographic code assignments for each i^{th} segment centroid.

According to a non-limiting embodiment or aspect, provided is a computer program product for segmenting geographic codes in a behavior-monitored system including a plurality of accounts, comprising at least one non-transitory computer-readable medium including program instructions that, when executed by at least one processor cause the at least one processor to: identify a plurality of geographic codes associated with the plurality of accounts, wherein each account of the plurality of accounts is associated with a geographic code of the plurality of geographic codes; receive geographic transaction metrics associated with each geographic code of the plurality of geographic codes; determine an optimal number of segments into which the plurality of geographic codes is to be segmented based at least partially on the geographic transaction metrics; segment the plurality of geographic codes into the optimal number of segments based at least partially on the geographic transaction metrics, such that each segment is associated with segment transaction metrics; and automatically implement a target action with respect to at least one account of the plurality of accounts based at least partially on the segment transaction metrics corresponding to at least one segment of the optimal number of segments.

Further embodiments or aspects are set forth in the following numbered clauses:

Clause 1. A computer-implemented method for segmenting geographic codes in a behavior-monitored system including a plurality of accounts, comprising: identifying, with at least one processor, a plurality of geographic codes associated with the plurality of accounts, wherein each account of the plurality of accounts is associated with a geographic code of the plurality of geographic codes; receiving, with at least one processor, geographic transaction metrics associated with each geographic code of the plurality of geographic codes; determining, with at least one processor, an optimal number of segments into which the plurality of geographic codes is to be segmented based at least partially on the geographic transaction metrics; segmenting, with at least one processor, the plurality of geographic codes into the optimal number of segments based at least partially on the geographic transaction metrics, such that each segment is associated with segment transaction metrics; and automatically implementing, with at least one processor, a target action with respect to at least one account of the plurality of accounts based at least partially on the segment transaction metrics corresponding to at least one segment of the optimal number of segments.

Clause 2. The method of clause 1, wherein the geographic transaction metrics define, for each geographic code of the plurality of geographic codes, proportions of transactions in a plurality of categories by a subset of accounts of the plurality of accounts associated with that geographic code.

Clause 3. The method of clauses 1 or 2, wherein the plurality of categories comprises at least two of the following: travel and entertainment transactions, retail transactions, dining transactions, everyday spending transactions, or any combination thereof.

Clause 4. The method of any of clauses 1-3, wherein the segment transaction metrics define, for each segment of the optimal number of segments, proportions of transactions in a plurality of categories by a subset of accounts of the plurality of accounts associated with that segment.

Clause 5. The method of any of clauses 1-4, further comprising analyzing, with at least one processor, proportions of transactions in the plurality of categories by the at least one account of the plurality of accounts with respect to the segment transaction metrics of the at least one segment of the number of segments.

Clause 6. The method of any of clauses 1-5, wherein the at least one segment of the optimal number of segments includes a geographic code associated with the at least one account.

Clause 7. The method of any of clauses 1-6, wherein the at least one segment of the optimal number of segments does not include a geographic code associated with the at least one account.

Clause 8. The method of any of clauses 1-7, wherein the at least one segment comprises a plurality of segments of the optimal number of segments.

Clause 9. The method of any of clauses 1-8, wherein the analyzing comprises monitoring the proportions of transactions in the plurality of categories by the at least one account with respect to the segment transaction metrics of the at least one segment of the optimal number of segments to detect fraudulent activity in the transactions of the at least one account, and wherein the target action comprises automatically suspending, with at least one processor and in response to detecting the fraudulent activity, at least one of a transaction activity of the at least one account and access of the at least one account to a system.

Clause 10. The method of any of clauses 1-9, wherein the at least one account comprises multiple accounts associated with transactions with a particular merchant, and wherein the analyzing comprises comparing a percentage of the proportions of the plurality of transactions in the plurality of categories by the multiple accounts that are associated with the particular merchant to the segment transaction metrics of the at least one segment of the optimal number of segments.

Clause 11. The method of any of clauses 1-10, wherein the target action comprises automatically enrolling, with at least one processor, the at least one account in an incentive program.

Clause 12. The method of any of clauses 1-11, wherein the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

Clause 13. The method of any of clauses 1-12, further comprising normalizing, with at least one processor, the plurality of geographic transaction metrics to a unified scale.

Clause 14. The method of any of clauses 1-13, wherein the unified scale is determined according to the following equation: VS=(VO−MM)/MSD, wherein VS is the scaled value of a geographic transaction metric, VO is the original, unscaled value of the geographic transaction metric, MM is the mean of all values of the geographic transaction metrics, and MSD is the standard deviation of the geographic transaction metric.

Clause 15. The method of any of clauses 1-14, wherein segmenting the plurality of geographic codes into the optimal number of segments of the plurality of geographic codes comprises applying, with at least one processor, at least one of the following algorithms: k-means clustering, hierarchical clustering, a neural network, a decision tree, or any combination thereof, to the plurality of geographic transaction metrics associated with the plurality of geographic codes.

Clause 16. The method of any of clauses 1-15, wherein the segmenting the plurality of geographic codes into the optimal number of segments of the plurality of geographic codes comprises applying, with at least one processor, k-means clustering, the method further comprising: determining centroids of the optimal number of segments; and iterating between a data assignment step and a centroid update step until a stopping criteria is met, wherein the data assignment step comprises: assigning each geographic code to a segment of the optimal number of segments according to the following equation:

$${arg min}_{{c}_{i} ∈ C} {dist ( {c}_{i} , x )}^{2}$$

wherein i is the optimal number of segments, C is a set of centroids cᵢ including the centroids of the optimal number of segments, x is a geographic code of the plurality of geographic codes, and dist(·) is the standard (L2) Euclidean distance between the geographic code x and the centroids cᵢ; wherein the centroid update step comprises: recalculating the centroids of the optimal number of segments according to the following equation:

$${c}_{i} = \frac{1}{\vert {S}_{i} \vert} {\sum }_{{x}_{i} ∈ {S}_{i}} {x}_{i}$$

wherein Sᵢ is set of geographic code assignments for each i^{th} segment centroid.

Clause 17. A system for segmenting geographic codes in a behavior-monitored system including a plurality of accounts, comprising at least one server computer including at least one processor, the at least one server computer programmed and/or configured to: identify a plurality of geographic codes associated with the plurality of accounts, wherein each account of the plurality of accounts is associated with a geographic code of the plurality of geographic codes; receive geographic transaction metrics associated with each geographic code of the plurality of geographic codes; determine an optimal number of segments into which the plurality of geographic codes is to be segmented based at least partially on the geographic transaction metrics; segment the plurality of geographic codes into the optimal number of segments based at least partially on the geographic transaction metrics, such that each segment is associated with segment transaction metrics; and automatically implement a target action with respect to at least one account of the plurality of accounts based at least partially on the segment transaction metrics corresponding to at least one segment of the optimal number of segments.

Clause 18. The system of clause 17, wherein the geographic transaction metrics define, for each geographic code of the plurality of geographic codes, proportions of transactions in a plurality of categories by a subset of accounts of the plurality of accounts associated with that geographic code.

Clause 19. The system of clauses 17 or 18, wherein the plurality of categories comprises at least two of the following: travel and entertainment transactions, retail transactions, dining transactions, everyday spending transactions, or any combination thereof.

Clause 20. The system of any of clauses 17-19, wherein the segment transaction metrics define, for each segment of the optimal number of segments, proportions of transactions in a plurality of categories by a subset of accounts of the plurality of accounts associated with that segment.

Clause 21. The system of any of clauses 17-20, wherein the at least one server computer is programmed and/or configured to: analyze proportions of transactions in the plurality of categories by the at least one account of the plurality of accounts with respect to the segment transaction metrics of the at least one segment of the number of segments.

Clause 22. The system of any of clauses 17-21, wherein the at least one segment of the optimal number of segments includes a geographic code associated with the at least one account.

Clause 23. The system of any of clauses 17-22, wherein the at least one segment of the optimal number of segments does not include a geographic code associated with the at least one account.

Clause 24. The system of any of clauses 17-23, wherein the at least one segment comprises a plurality of segments of the optimal number of segments.

Clause 25. The system of any of clauses 17-24, wherein the at least one server computer is programmed and/or configured to: monitor the proportions of transactions in the plurality of categories by the at least one account with respect to the segment transaction metrics of the at least one segment of the optimal number of segments to detect fraudulent activity in the transactions of the at least one account; and automatically implement the target action by automatically suspending, in response to detecting the fraudulent activity, at least one of a transaction activity of the at least one account and access of the at least one account to a system.

Clause 26. The system of any of clauses 17-25, wherein the at least one account comprises multiple accounts associated with transactions with a particular merchant, and wherein the at least one server computer is programmed and/or configured to: compare a percentage of the proportions of the plurality of transactions in the plurality of categories by the multiple accounts that are associated with the particular merchant to the segment transaction metrics of the at least one segment of the optimal number of segments.

Clause 27. The system of any of clauses 17-26, wherein the at least one server computer is programmed and/or configured to: automatically implement the target action by automatically enrolling the at least one account in an incentive program.

Clause 28. The system of any of clauses 17-27, wherein the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

Clause 29. The system of any of clauses 17-28, wherein the at least one server computer is programmed and/or configured to: normalize the plurality of geographic transaction metrics to a unified scale.

Clause 30. The system of any of clauses 17-29, wherein the unified scale is determined according to the following equation: VS=(VO−MM)/MSD, wherein VS is the scaled value of a geographic transaction metric, VO is the original, unscaled value of the geographic transaction metric, MM is the mean of all values of the geographic transaction metrics, and MSD is the standard deviation of the geographic transaction metric.

Clause 31. The system of any of clauses 17-30, wherein the at least one server computer is programmed and/or configured to segment the plurality of geographic codes into the optimal number of segments of the plurality of geographic codes by applying at least one of the following algorithms: k-means clustering, hierarchical clustering, a neural network, a decision tree, or any combination thereof, to the plurality of geographic transaction metrics associated with the plurality of geographic codes.

Clause 32. The system of any of clauses 17-31, wherein the at least one server computer is programmed and/or configured to segment the plurality of geographic codes into the optimal number of segments by applying k-means clustering, t wherein the at least one server computer is programmed and/or configured to: determine centroids of the optimal number of segments; and iterate between a data assignment step and a centroid update step until a stopping criteria is met, wherein the data assignment step comprises: assigning each geographic code to a segment of the optimal number of segments according to the following equation:

$${arg min}_{{c}_{i} ∈ C} {dist ( {c}_{i} , x )}^{2}$$

wherein i is the optimal number of segments, C is a set of centroids cᵢ including the centroids of the optimal number of segments, x is a geographic code of the plurality of geographic codes, and dist(·) is the standard (L₂) Euclidean distance between the geographic code x and the centroids cᵢ; wherein the centroid update step comprises: recalculating the centroids of the optimal number of segments according to the following equation:

$${c}_{i} = \frac{1}{\vert {S}_{i} \vert} {\sum }_{{x}_{i} ∈ {S}_{i}} {x}_{i}$$

wherein Sᵢ is set of geographic code assignments for each i^{th} segment centroid.

Clause 33. A computer program product for segmenting geographic codes in a behavior-monitored system including a plurality of accounts, comprising at least one non-transitory computer-readable medium including program instructions that, when executed by at least one processor cause the at least one processor to: identify a plurality of geographic codes associated with the plurality of accounts, wherein each account of the plurality of accounts is associated with a geographic code of the plurality of geographic codes; receive geographic transaction metrics associated with each geographic code of the plurality of geographic codes; determine an optimal number of segments into which the plurality of geographic codes is to be segmented based at least partially on the geographic transaction metrics; segment the plurality of geographic codes into the optimal number of segments based at least partially on the geographic transaction metrics, such that each segment is associated with segment transaction metrics; and automatically implement a target action with respect to at least one account of the plurality of accounts based at least partially on the segment transaction metrics corresponding to at least one segment of the optimal number of segments.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the non-limiting embodiments or aspects that are illustrated in the accompanying schematic figures, in which:

FIG. 1 is a schematic diagram of a system for segmenting geographic codes in a behavior-monitored system including a plurality of accounts according to the principles of the present invention;

FIG. 2 is another schematic diagram of a system for segmenting geographic codes in a behavior-monitored system including a plurality of accounts according to the principles of the present invention;

FIG. 3 is another schematic diagram of a system for segmenting geographic codes in a behavior-monitored system including a plurality of accounts according to the principles of the present invention;

FIG. 4 is another schematic diagram of a system for segmenting geographic codes in a behavior-monitored system including a plurality of accounts according to the principles of the present invention;

FIG. 5 is another schematic diagram of a system for segmenting geographic codes in a behavior-monitored system including a plurality of accounts according to the principles of the present invention;

FIG. 6 is another schematic diagram of a system for segmenting geographic codes in a behavior-monitored system including a plurality of accounts according to the principles of the present invention;

FIG. 7 is another schematic diagram of a system for segmenting geographic codes in a behavior-monitored system including a plurality of accounts according to the principles of the present invention;

FIG. 8 is another schematic diagram of a system for segmenting geographic codes in a behavior-monitored system including a plurality of accounts according to the principles of the present invention;

FIG. 9 is another schematic diagram of a system for segmenting geographic codes in a behavior-monitored system including a plurality of accounts according to the principles of the present invention;

FIG. 10 is a flow diagram of a method for segmenting geographic codes in a behavior-monitored system including a plurality of accounts according to the principles of the present invention;

FIG. 11 is a sequence diagram for segmenting geographic codes in a behavior-monitored system including a plurality of accounts according to principles of the present invention;

FIG. 12A is a table listing transaction data categories used for determining geographic transaction metrics in a non-limiting exemplary process described in FIG. 8;

FIG. 12B is a table listing segment transaction metrics associated with segments of geographic codes in a non-limiting exemplary process described in FIG. 8; and

FIG. 13 is a sequence diagram for segmenting geographic codes in a behavior-monitored system including a plurality of accounts according to principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step or step sequences, except where expressly specified to the contrary. It is also to be understood that the specific devices and processes illustrated in the attached drawings, and described in the following specification, are simply non-limiting embodiments or aspects of the invention. Hence, specific dimensions and other physical characteristics related to the non-limiting embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the terms “issuing institution,” “portable financial device issuer,” “issuer,” or “issuer bank” may refer to one or more entities that provide accounts to customers for conducting payment transactions, such as initiating credit and/or debit payments. For example, an issuing institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases, such that they may be used to conduct a transaction without directly using the original account identifier. In some examples, an original account identifier, such as a PAN, may be associated with a plurality of tokens for different individuals or purposes. An issuing institution may be associated with a bank identification number (BIN) that uniquely identifies it. The terms “issuer” and “issuer server” may also refer to one or more computer systems operated by or on behalf of an issuing institution, such as a server computer executing one or more software applications. For example, an issuer system may include one or more authorization servers for authorizing or effecting a payment transaction.

As used herein, the term “merchant” refers to an individual or entity that provides goods and/or services, or access to goods and/or services, to customers (also referred to herein as a “consumer”) based on a transaction, such as a payment transaction. “Merchant” or “merchant server” may also refer to one or more computer systems operated by or on behalf of a merchant, such as a server computer executing one or more software applications. As used herein, a “merchant system” may refer to one or more computers and/or peripheral devices used by a merchant to engage in or facilitate payment transactions with customers, including one or more point-of-sale (POS) devices, one or more card readers, near-field communication (NFC) receivers, RFID receivers, and/or other contactless transceivers or receivers, contact-based receivers, payment terminals, computers, servers, input devices, and/or other like devices that may be used to initiate, facilitate, or process a payment transaction. A merchant system may also include one or more server computers programmed and/or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer. The term “transaction service provider” may also refer to one or more computer systems operated by or on behalf of a transaction service provider, such as a server computer executing one or more software applications (“transaction processing server”, e.g., VisaNet). The term “transaction processing server” (or system), may include one or more computers, processors, storage devices, network interfaces, and executable instructions or code in the form of applications, APIs, software, firmware, code modules and the like operating in a network environment. When a user engages or initiates a transaction with a merchant at a point-of-sale, he or she will interact with a point-of-sale system, e.g., using a credit card, portable financial device, payment device, and/or mobile device to interact either directly or indirectly with a reader device communicating as or within the point-of-sale system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “originator” may refer to an entity that offers OCT, AFT, multi-OCT, multi-AFT, or some combination thereof services to its consumers. The originator may be a merchant, as defined above. In addition to being a merchant, the originator may or may not also be an acquirer of the transaction service provider. If the originator is not also an acquirer associated with the transaction service provider, the originator may be sponsored by an acquirer associated with the transaction service provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information, such as an account identifier or a name of the account holder. As used herein, the information or data associated with the “portable financial device” may be used to conduct electronic or online transactions with one or more merchants, such as through on online location of the merchant.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “payment facilitator” may refer to a payment processing system operated by or on behalf of an entity that contracts with an acquirer to provide transaction service provider payment services using portable financial devices of the transaction service provider to merchants sponsored by the payment facilitator. A payment facilitator may also refer to the entity that operates such a payment processing system. The payment facilitator may execute a merchant acceptance agreement on behalf of an acquirer and/or receive settlement of transaction proceeds from an acquirer on behalf of a sponsored merchant. The payment facilitator may monitor all of its sponsored merchant activity in accordance with regulations of the transaction service provider.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant system.

Non-limiting embodiments or aspects of the present invention are directed to a method, system, and computer program product for segmenting geographic codes in a behavior-monitored system including a plurality of accounts. Geographic codes may refer to U.S. zip codes, Metropolitan Statistical Areas (MSA), Core-based Statistical Areas (CBSA), Designated Market Areas (DMA), Geographic Identifiers (GEOIDs), census geographic units, e.g., the Canadian Standard Geographical Classification (SGC) or the Office for National Statistics (ONS) codes of the United Kingdom, U.S. or foreign states or provinces, U.S. or foreign counties, U.S. or foreign cities, U.S. or foreign education and/or political districts, country codes, e.g., international subscriber dialing (ISD) codes, national postcodes, e.g., Canadian postcodes, British postcodes, and the like, and/or any other designation or code that defines a geographical boundary that can indicate a location. In some examples, a geographic code may be associated with an account, such as a U.S. zip code of a billing address associated with the account. In other examples, a geographic code may be associated with a location of a financial transaction conducted with a portable financial device of an account, such as a U.S. zip code of a merchant at which the financial transaction is conducted.

Portable financial device transactions may refer to transactions initiated with a personal financial device and an account identifier. Non-limiting embodiments or aspects of the invention allow for issuing institutions, acquirers, and/or transaction service providers to segment geographic codes in a behavior-monitored system including a plurality of accounts for monitoring and analyzing financial transactions with respect to geographic designations or codes in manner that takes into account transaction behavior of the accounts associated with the geographic designations so as to be able to more efficiently determine users or accounts more likely to be receptive to specific messages and incentives regarding use or increased use of their portable financial devices, detect fraudulent activity in the financial transactions of the accounts, and/or provide geographic benchmarking of specific locations. For example, issuing institutions, acquirers, and/or transaction service providers can segment the geographic codes to generate segments with unique transaction characteristics and identify segments with relatively heavy or light spending in particular transaction data categories. In one example, the issuing institutions, acquirers, and/or transaction service providers can target subsets of users in the identified segments according to the transaction characteristics of the segments, which enables more tailored and effective messages and marketing campaigns than messages and campaigns that are based solely on geographical boundaries and do not take into account transaction behavior. In other examples, the issuing institutions, acquirers, and/or transaction service providers can compare past, current, and/or future transaction data of accounts to determine significant similarities or differences between a particular account's transaction data and the transaction characteristics of the segments, and the similarities and/or differences therebetween can be used to determine or detect fraudulent activity in the financial transactions of the accounts, which enables more effective fraud detection than conventional fraud detection systems that are based only on a user's own transaction history and/or the transaction history of users within the same geographical boundary that does not take into account transaction behavior. In another example, the issuing institutions, acquirers, and/or transaction service providers can use the segments to benchmark business performance in specific locations against business performance in other locations and/or an overall performance of the business, which can be used to identify locations where market share for the business is increasing or decreasing.

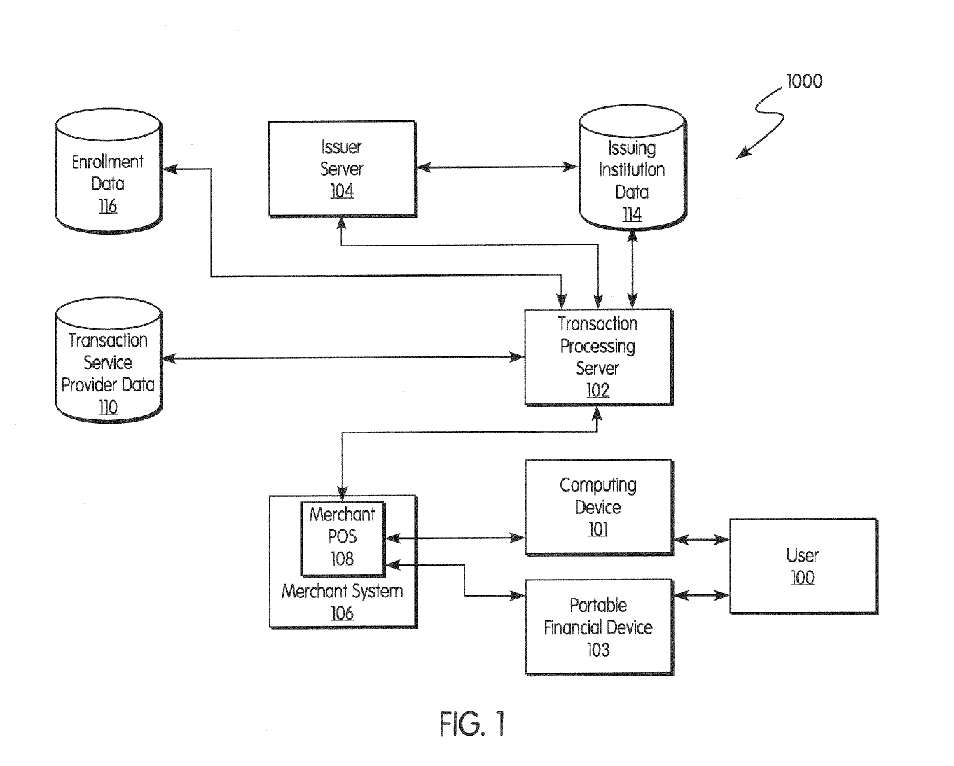

Referring now to FIG. 1, a system 1000 for segmenting geographic codes in a behavior-monitored system including a plurality of accounts is shown according to a non-limiting embodiment or aspect. A user 100 may be a holder of a portable financial device 103 (e.g., an account holder) associated with a transaction service provider including transaction processing server 102 and issued to the user 100 by an issuing institution including issuer server 104. In some non-limiting embodiments or aspects, the user 100 is a holder of a portable financial device 103 issued by an issuer bank. The user 100 may use the portable financial device 103 to initiate financial transactions with various merchant systems 106 using a merchant POS 108, which communicates with the transaction processing server 102 to complete payment of the financial transactions. In some non-limiting embodiments or aspects, the user 100 may purchase goods or services from the merchant system 106 using the portable financial device 103 and the merchant POS 108 to guarantee payment for the goods and/or services by authorization requests approved by the transaction processing server 102.

In the example system 1000 shown in FIG. 1, the merchant POS 108 may communicate with the transaction processing server 102 during financial transactions between the user 100 and the merchant system 106. During these transactions, the transaction processing server 102 may collect transaction data relating to the financial transactions and communicate that data to a transaction service provider database 110. The transaction service provider database 110 can store personal information (e.g., name, age, gender, mailing address including zip code, phone number, email address, social security number, driver's license number, marital status, occupation, etc.), and/or various financial information (e.g., credit score, credit score history, bank account number, account identifier, monthly salary, yearly salary, etc.) about a plurality of users associated with accounts for portable financial devices associated with the transaction service provider. The transaction service provider database 110 may be located at or remote from the transaction processing server 102. Over time, the transaction service provider database 110 may collect historical transaction data (used interchangeably with “past transaction data”) and other information about a plurality of users who use portable financial devices 103 associated with the transaction service provider. For example, the transaction processing server 102 may collect various information about each of the account holders of the transaction service provider, including information about each purchase or non-purchase transaction that account holder has made using portable financial devices associated with the transaction service provider. This historical transaction data may be later processed by the transaction processing server 102.

Accounts of the transaction service provider can be associated with geographic codes in the transaction service provider database 110. For example, each account may be directly associated with a geographic code, such as a U.S. zip code and/or a U.S. state of a fixed billing address associated with the account and/or user 100. In other examples, accounts may be indirectly associated with geographic codes, for example, due to financial transactions conducted with a portable financial device 103 of the account at a geographic code associated with a merchant system 106, such as a U.S. zip code and/or a U.S. state of the merchant system 106 at which the financial transaction is conducted. Non-limiting embodiments or aspects disclosed herein are generally described with respect to segmenting geographic codes associated directly with accounts, e.g., with a U.S. zip code and/or a U.S. state of the fixed billing address of the account and/or user 100, and not with respect to geographic codes that may be indirectly associated with the accounts due to transactions conducted by the accounts at merchant systems 106 in various geographic locations; however, non-limiting embodiments or aspects are not limited thereto and it is contemplated that a method, system, and apparatus for segmenting geographic codes in a behavior-monitored system including a plurality of accounts according to non-limiting embodiments or aspects of the present invention can be applied to geographic codes that are, in any manner, indirectly associated with accounts of the transaction service provider. Accordingly, in some examples, generated segments may include segments of geographic codes indicating relatively fixed locations of the accounts or users 100 that conduct transactions and, in other examples, generated segments may include segments of geographic codes indicating varying locations at which transactions for the accounts or users 100 occurred.

The transaction processing server 102 can receive or determine a plurality of geographic transaction metrics associated with each geographic code of the plurality of geographic codes. For example, the transaction processing server 102 may determine the geographic transaction metrics based on the historical transaction data and other information about the plurality of accounts associated with portable financial devices associated with the transaction service provider and store the geographic transaction metrics in the transaction service provider database 110. The geographic transaction metrics define, for each geographic code, proportions of transactions in a plurality of transaction data categories by a subset of accounts associated with that geographic code. The geographic transaction metrics may be normalized to a unified scale, e.g., a numeric fraction.

In some non-limiting embodiments or aspects, the transaction service provider database 110 and geographic transaction metrics may include the following transaction data categories: travel and entertainment transactions, retail transactions, dining transactions, “everyday” spending transactions, or any combination thereof. For example, the geographic transaction metrics can define, for each geographic code, proportions of transactions in travel and entertainment transactions, retail transactions, dining transactions, everyday spending transactions, or any combination thereof, by the subset of accounts associated with that particular geographic code. Travel and entertainment category transactions may include transactions related to airlines, lodging, vehicle rental, entertainment and travel services, and the like. Retail category transactions may include transactions related to apparel and accessories, department stores, discount stores, general retail goods, electronics and home improvement stores, and the like. Dining category transactions may include transactions related to restaurants and quick service restaurants, and the like. Everyday spending category transactions may include transactions related to food and groceries, fuel, transportation, drugstores and pharmacies, and the like. Travel and entertainment transactions, retail transactions, and dining transactions may be defined as discretionary spending. Everyday spending transactions may be defined as non-discretionary spending. Any other metric may be included that is determined to be relevant for defining the purchasing or spending behavior of a cardholder, detecting fraud, and/or providing geographic-based benchmarking.

In some non-limiting embodiments or aspects, the transaction service provider database 110 and geographic transaction metrics may include more narrowly defined transaction data categories, such as transaction data categories defined based on Merchant Category Classification (MCC) codes. MCC is used to classify a merchant by the type of goods or services the merchant provides. MCC codes can be assigned by merchant type, (e.g., one for hotels, one for office supply stores, etc.), or by merchant name (e.g., 3000 for United Airlines).

In other non-limiting embodiments or aspects, the transaction service provider database 110 and geographic transaction metrics may include one or more of the following transaction data categories: amount of cash withdrawals using the portable financial device (e.g., ATM withdrawals), date and time of each cash withdrawals using the portable financial device, days since last transaction, location of each cash withdrawal using the portable financial device, average international ticket size, date and time of each international purchase, location of each international purchase, merchant of each international purchase, goods or services bought for each international purchase, increase in amount of withdrawals (growth momentum of ticket size) over a given period (e.g., a month, a year, etc.), number of days since last portable financial device transaction, number of months in which cash was withdrawn using the portable financial device over a given period, number of consecutive months in which cash was withdrawn using the portable financial device over a given period (e.g., withdrawal consistency), portable financial device type (e.g., type of credit/debit card), the overall number of transactions using the portable financial device, the number of domestic transactions using the portable financial device, increase in amount of spending (e.g., growth momentum of monthly spending) over a given period (e.g., a month, a year, etc.), amount spent in each portable financial device transaction, date and time of each portable financial device transaction, merchant involved in each portable financial device transaction, goods and services bought and price of each good or service bought in each portable financial device transaction, category of goods and services bought in each portable financial device transaction, number of market categories active, number of market categories active over a given period, number of supermarket transactions over a given period, amount spent in supermarket transactions over a given period, amount spent at restaurants over a given period, number of restaurant transactions over a given period, amount spent at gas stations over a given period, number of gas station transactions over a given period, amount spent at entertainment merchants over a given period, number of entertainment transactions over a given period, amount spent at automotive merchants over a given period, number of automotive transactions over a given period, amount spent at clothing merchants over a given period, number of clothing transactions over a given period, amount spent on luxury goods over a given period, number of luxury good transactions over a given period, or number of transactions and amount spent for other specific goods or services found to be relevant for projecting an account holder's propensity to more frequently use their portable financial device, number of cash advances using the portable financial device over a given period, amount of cash advances using the portable financial device, credit score, credit score history, and other similar or related metrics regarding use of the portable financial device by the user 100.

With continued reference to FIG. 1, the transaction service provider database 110 may be in communication with the transaction processing server 102. The transaction service provider processor 102 may also be in communication with an issuing institution database 114 which, like the transaction service provider database 110, may include information about each user. The issuing institution database 114 may be located at or remote from the issuer server 104. The issuing institution database 114 may include information about each user collected by the issuer server 104. In some non-limiting embodiments or aspects, the issuing institution database 114 may include the following information: personal information (e.g., name, age, gender, mailing address including zip code, phone number, email address, social security number, driver's license number, marital status, occupation, etc.), and/or various financial information (e.g., credit score, credit score history, bank account number, account identifier, monthly salary, yearly salary, etc.). Some of the information in the transaction service provider database 110 and the issuing institution database 114 may be duplicative.

The transaction processing server 102 may also be in communication with an enrollment database 116. In FIG. 1, the enrollment database 116 is maintained by or on behalf of the transaction service provider. In other non-limiting examples, an enrollment database may be maintained by or on behalf of the issuing institution, the merchant, an acquirer, or other entity. The enrollment database 116 may include information about users that are enrolled in one or more incentive programs offered by the transaction service provider. Users not currently enrolled in a transaction service provider incentive program may be enrolled in a transaction service provider incentive program by being added to the enrollment database 116 by the transaction processing server 102. The enrollment database 116 may also include specific information regarding the incentive programs being offered, such as expiration dates, terms and conditions, etc.

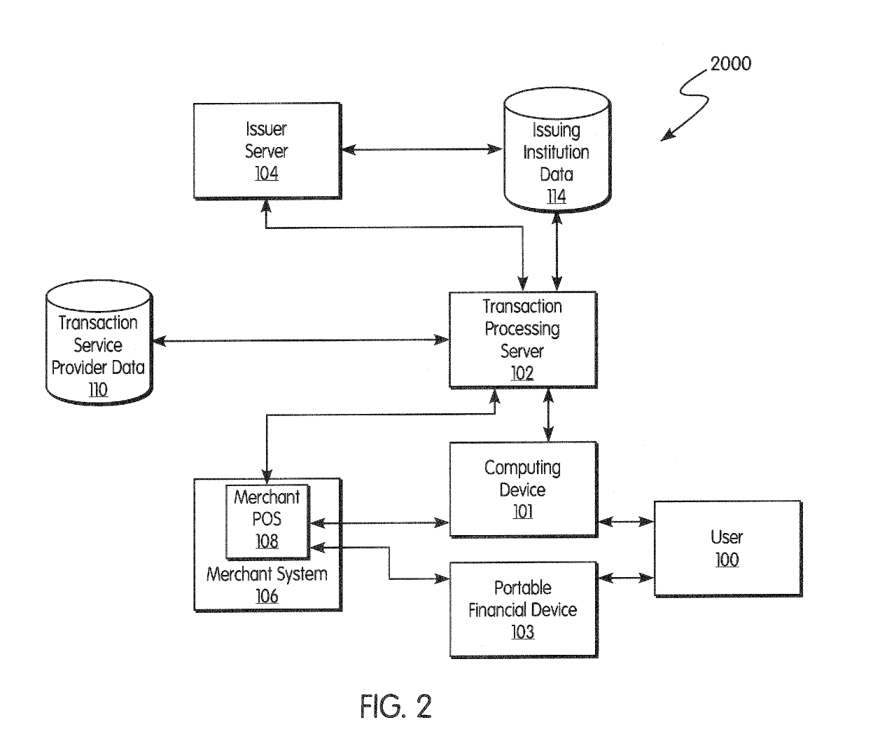

Referring to FIG. 2, a system 2000 for segmenting geographic codes in a behavior-monitored system including a plurality of accounts is shown according to a non-limiting embodiment or aspect. The components of the system 2000 in FIG. 2 include all of the capabilities and characteristics of the components from the system 1000 of FIG. 1 having like reference numbers. In a non-limiting embodiment or aspect of the system 2000 shown in FIG. 2, the transaction processing server 102 may communicate with a computing device 101 of the user 100. Such communication may include a web-based communication, an email communication, a text message, a telephone call, a push notification, and/or an instant message. The user 100 may also communicate with the transaction processing server 102 using like communication methods.

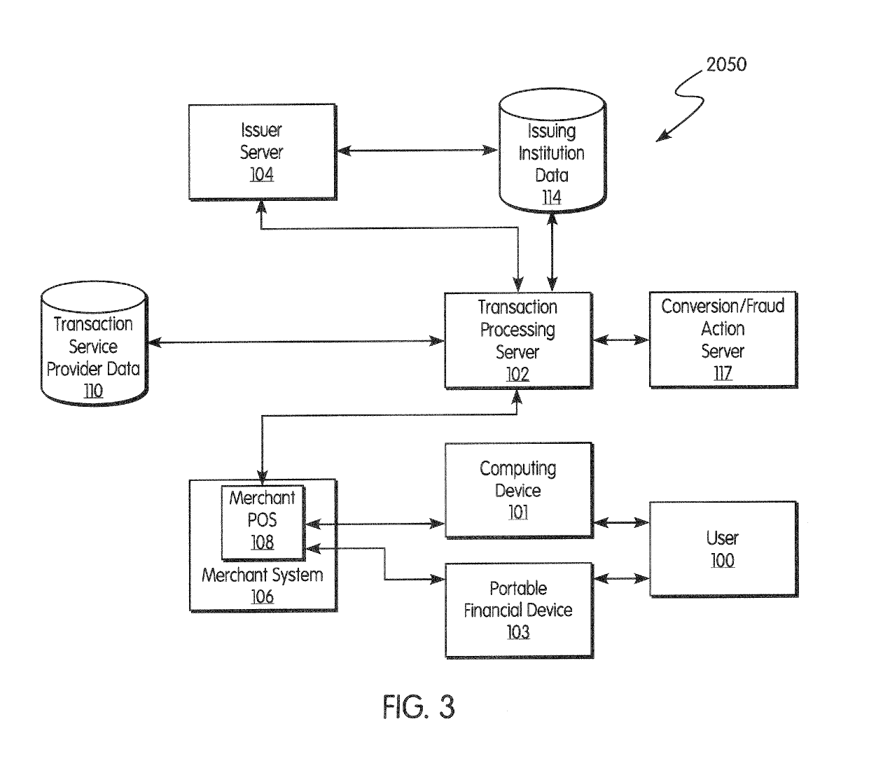

Referring to FIG. 3, a system 2050 for segmenting geographic codes in a behavior-monitored system including a plurality of accounts is shown according to a non-limiting embodiment or aspect. The components of the system 2050 in FIG. 3 include all of the capabilities and characteristics of the components from the system 1000 of FIG. 1 having like reference numbers. In a non-limiting embodiment or aspect of the system 2050 shown in FIG. 3, the transaction processing server 102 may initiate a target action, which may include a conversion action or a fraud deterrence action, by transmitting a signal to a conversion/fraud deterrence action server 117. The conversion/fraud deterrence action server 117 may be a separate computer system or, in other examples, may be a part of the transaction processing server 102. Although shown as a combined conversion/fraud deterrence action server 117 in FIG. 3 for the sake of simplicity, in some examples, the conversion action server may be a separate computer system from the fraud deterrence action server or, in other examples, one or both of the conversion action server and the fraud deterrence action server may be a part of the service processing server 102.

A conversion action may include automatic enrollment in at least one incentive program and/or transmitting a communication to a user 100 (as described and shown in FIGS. 1 and 2). A conversion action may also include any other action directed to incentivizing, educating, or encouraging a user 100 in the subset to more frequently use their portable financial device 103. A fraud deterrence action may include automatic monitoring of the transactions of the account or user 100 and/or automatic suspension, in response to detection of fraudulent activity, of at least one of a transaction activity of the account or user 100 and access of the account or user 100 to a system, e.g., to a system or subsystem of the transaction processing server 102 and/or the issuer server 104. A fraud deterrence action may also include any other action directed to detecting, deterring, or preventing fraudulent activity associated with a portable financial device 103 of a user 100.

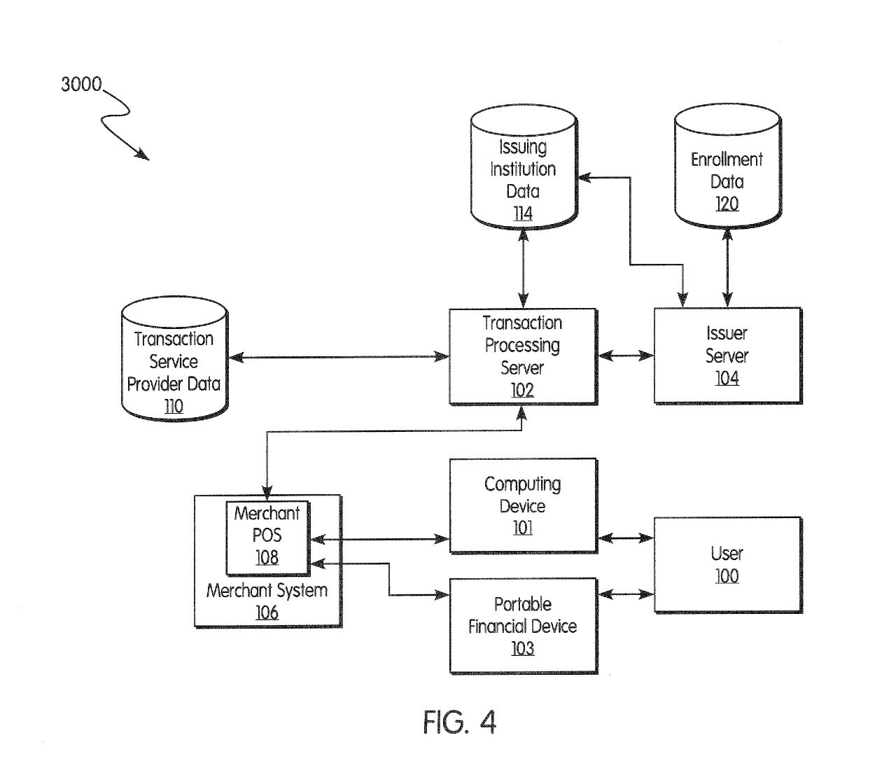

Referring to FIG. 4, a system 3000 for segmenting geographic codes in a behavior-monitored system including a plurality of accounts is shown according to a non-limiting embodiment or aspect. The components of the system 3000 shown in FIG. 4 include all of the capabilities and characteristics of the components from the system 1000 of FIG. 1 having like reference numbers. In a non-limiting embodiment or aspect of the system 3000 shown in FIG. 4, the transaction processing server 102 may be in communication with an issuer server 104. The issuer server 104 may be owned and/or controlled by or on behalf of the issuing institution. The issuer server 104 may be located remotely from the transaction processing server 102. The issuer server 104 may also be in communication with an enrollment database 120 of the issuing institution. The enrollment database 120 may include information about users that are enrolled in one or more incentive programs offered by the issuing institution. Users not currently enrolled in an issuing institution incentive program may be enrolled in an issuing institution incentive program by being added to the enrollment database 120 by the issuer server 104. The enrollment database 120 may also include specific information regarding the incentive programs being offered.

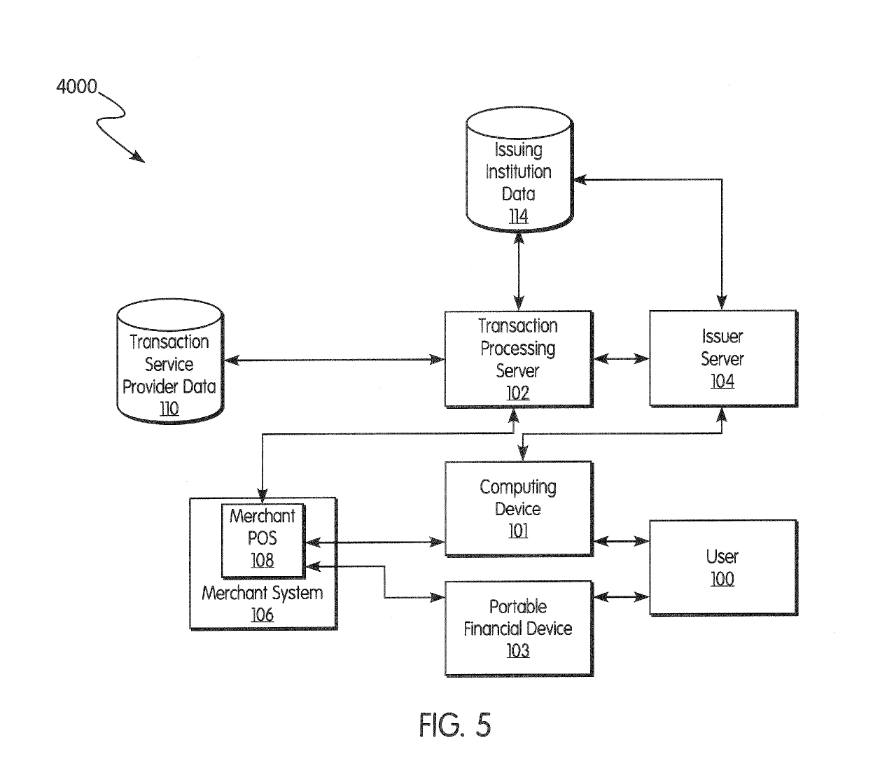

Referring to FIG. 5, a system 4000 for segmenting geographic codes in a behavior-monitored system including a plurality of accounts is shown according to a non-limiting embodiment or aspect. The components of the system 4000 shown in FIG. 5 include all of the capabilities and characteristics of the components from the system 3000 of FIG. 4 having like reference numbers. In a non-limiting embodiment or aspect of the system 4000 shown in FIG. 5, the issuer server 104 may communicate with a computing device 101 of the user 100. Such communication may include a web-based communication, an email communication, a text message, a telephone call, a push notification, and/or an instant message. The user 100 may also communicate with the issuer server 104 using like communication methods.

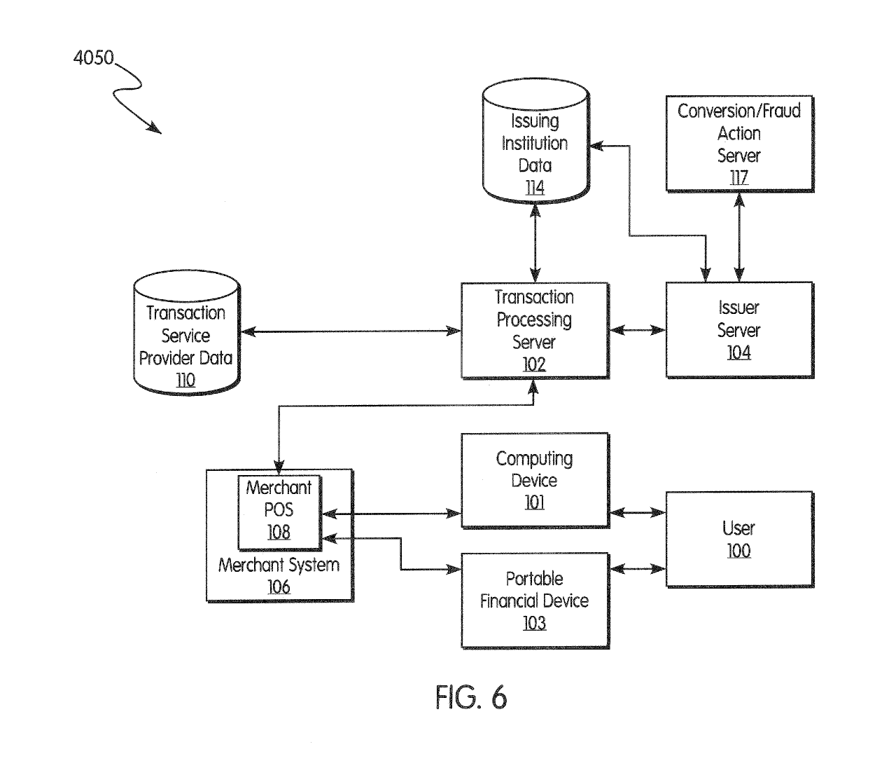

Referring to FIG. 6, a system 4050 for segmenting geographic codes in a behavior-monitored system including a plurality of accounts is shown according to a non-limiting embodiment or aspect. The components of the system 4050 shown in FIG. 6 include all of the capabilities and characteristics of the components from the system 3000 of FIG. 4 having like reference numbers. In a non-limiting embodiment or aspect of the system 4050 shown in FIG. 6, the issuer server 104 may initiate a conversion action (or a fraud deterrence action) using the conversion/fraud deterrence action server 117. The conversion/fraud deterrence action processor 117 may be a separate computer system or, in other examples, may be a part of the issuer server 104. This conversion action may include automatic enrollment in at least one incentive program and/or transmitting a communication to a user 100 (as described and shown in FIGS. 4 and 5). A conversion action may also include any other action directed to incentivizing, educating, or encouraging a user 100 in the subset to more frequently use their portable financial device 103. A fraud deterrence action may include automatic monitoring of the transactions of the account or user 100 and/or automatic suspension, in response to detection of fraudulent activity, of at least one of a transaction activity of the account or user 100 and access of the account or user 100 to a system, e.g., to a system or subsystem of the transaction processing server 102 and/or the issuer server 104. A fraud deterrence action may also include any other action directed to detecting, deterring, or preventing fraudulent activity associated with a portable financial device of a user 100.

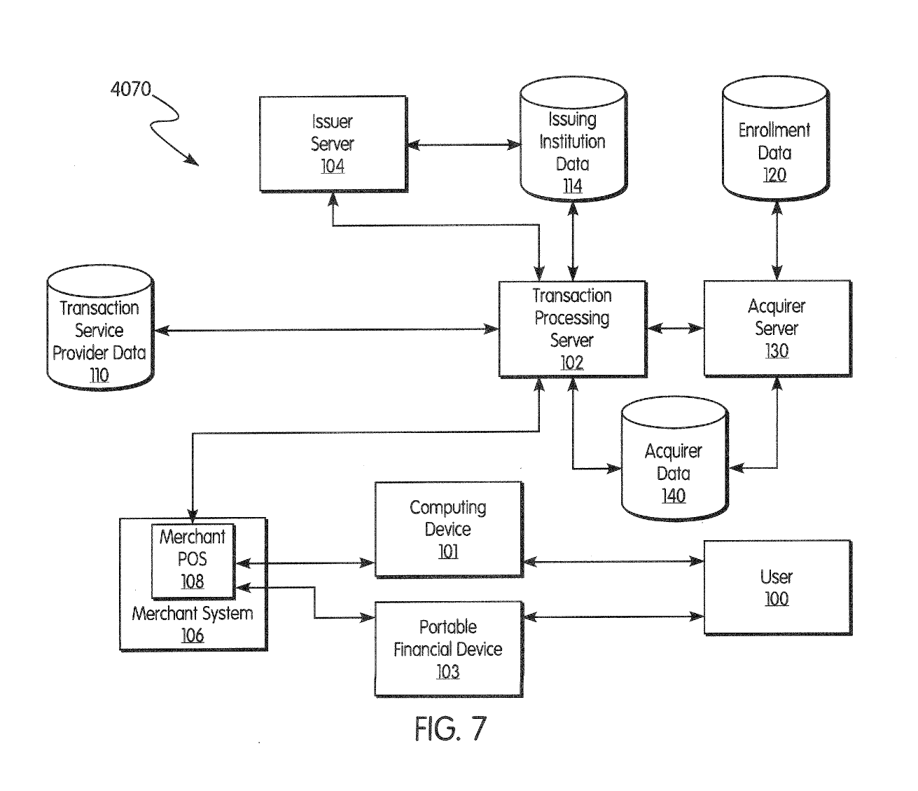

Referring to FIG. 7, a system 4070 for segmenting geographic codes in a behavior-monitored system including a plurality of accounts is shown according to a non-limiting embodiment or aspect. The components of the system 4070 shown in FIG. 7 include all of the capabilities and characteristics of the components from the system 1000 of FIG. 1 having like reference numbers. In a non-limiting embodiment or aspect of the system 4070 shown in FIG. 7, the transaction processing server 102 may be in communication with an acquirer server 130. An acquirer database 140 may be in communication with the transaction processing server 102 and the acquirer server 130. The acquirer database 140, like the transaction service provider database 110, may include information about each user. The acquirer database 140 may be located at or remote from the acquirer server 130. The acquirer database 140 may include information about each user collected by the acquirer server 130. In some non-limiting embodiments or aspects, the acquirer database 140 may include the following information: personal information (e.g., name, age, gender, mailing address including zip code, phone number, email address, social security number, driver's license number, marital status, occupation, etc.), and/or various financial information (e.g., credit score, credit score history, bank account number, account identifier, monthly salary, yearly salary, etc.). Some of the information in the transaction service provider database 110 and the acquirer database 140 may be duplicative.

The acquirer server 130 may be located remotely from the transaction processing server 102 and/or the issuer server 104. The acquirer server 130 may also be in communication with an enrollment database 120. The enrollment database 120 may include information about users that are enrolled in one or more incentive programs offered by the acquirer, e.g., a merchant bank. Users not currently enrolled in an acquirer incentive program may be enrolled in an acquirer incentive program by being added to the enrollment database 120 by the acquirer server 130. The enrollment database 120 may also include specific information regarding the incentive programs being offered.

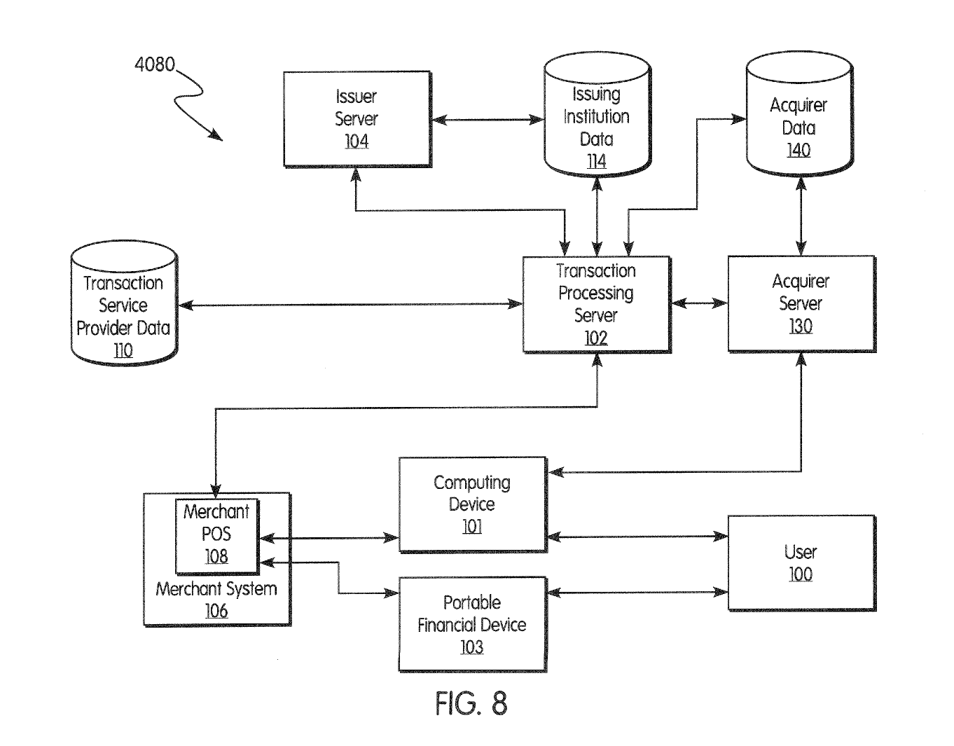

Referring to FIG. 8, a system 4080 for segmenting geographic codes in a behavior-monitored system including a plurality of accounts is shown according to a non-limiting embodiment or aspect. The components of the system 4080 shown in FIG. 8 include all of the capabilities and characteristics of the components from the system 4070 of FIG. 7 having like reference numbers. In a non-limiting embodiment or aspect of the system 4080 shown in FIG. 8, the acquirer server 130 may communicate with a computing device 101 of the user 100. Such communication may include a web-based communication, an email communication, a text message, a telephone call, a push notification, and/or an instant message. The user 100 may also communicate with the acquirer server 130 using like communication methods.

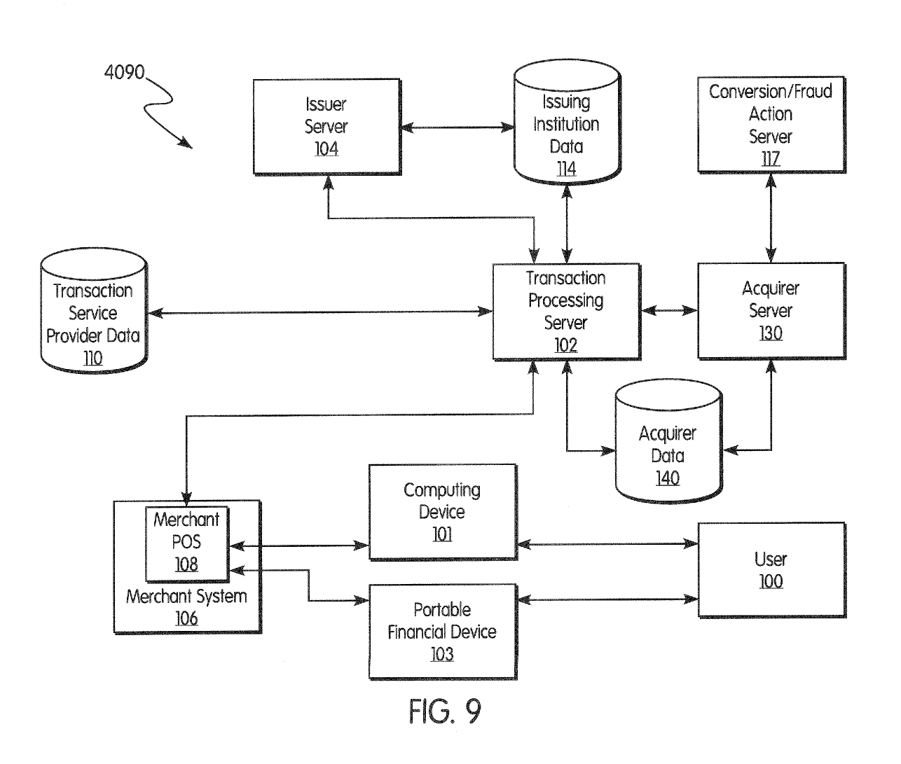

Referring to FIG. 9, a system 4090 for segmenting geographic codes in a behavior-monitored system including a plurality of accounts is shown according to a non-limiting embodiment or aspect. The components of the system 4090 shown in FIG. 9 include all of the capabilities and characteristics of the components from the system 4070 of FIG. 7 having like reference numbers. In a non-limiting embodiment or aspect of the system 4090 shown in FIG. 9, the acquirer server 130 may initiate a conversion action (or a fraud deterrence action) using the conversion/fraud deterrence action server 117. The conversion/fraud deterrence action server 117 may be a separate computer system or, in other examples, may be a part of the acquirer server 130. This conversion action may include automatic enrollment in at least one incentive program and/or transmitting a communication to a computing device 101 of a user 100 (as described and shown in FIGS. 7 and 8). A conversion action may also include any other action directed to incentivizing, educating, or encouraging a user 100 in the subset to more frequently use their portable financial device. A fraud deterrence action may include automatic monitoring of the transactions of the account or user 100 and/or automatic suspension, in response to detection of fraudulent activity, of at least one of a transaction activity of the account or user 100 and access of the account or user 100 to a system, e.g., to a system or subsystem of the transaction processing server 102, the issuer server 104, and/or the acquirer server 130. A fraud deterrence action may also include any other action directed to detecting, deterring, or preventing fraudulent activity associated with a portable financial device 103 of a user 100.

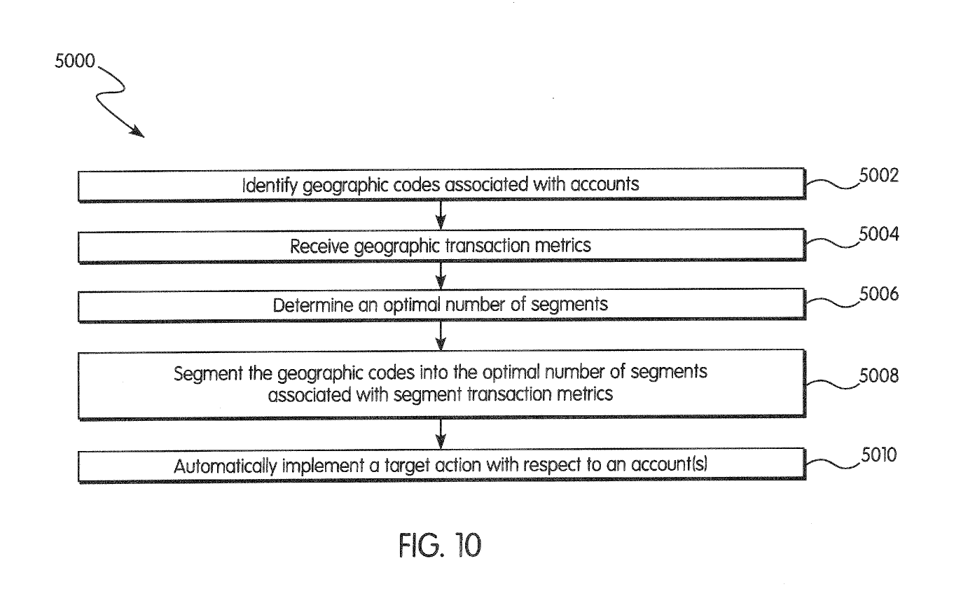

Referring to FIG. 10, a method 5000 is shown for segmenting geographic codes in a behavior-monitored system including a plurality of accounts. The method 5000 includes a step 5002 of identifying a plurality of geographic codes associated with the plurality of accounts, wherein each account of the plurality of accounts is associated with a geographic code of the plurality of geographic codes. At step 5004, geographic transaction metrics associated with each geographic code of the plurality of geographic codes are received. At step 5006, determining, with at least one processor, an optimal number of segments into which the plurality of geographic codes is to be segmented based at least partially on the geographic transaction metrics is performed. At step 5008, segmenting, with at least one processor, the plurality of geographic codes into the optimal number of segments based at least partially on the geographic transaction metrics, such that each segment is associated with segment transaction metrics, is performed. At step, 5010, automatically implementing, with at least one processor, a target action with respect to at least one account of the plurality of accounts based at least partially on the segment transaction metrics corresponding to at least one segment of the optimal number of segments is performed.

With continued reference to FIG. 10, and referring back to FIG. 1, step 5002 may include determining a plurality of accounts that are associated with geographic codes, e.g., residence U.S. zip codes, in the transaction service provider database 110, the issuing institution database 114, and/or the enrollment database 116, and identifying the geographic codes associated with the determined accounts. The plurality of accounts may include all accounts or cards associated with the transaction service provider that are associated with the geographic codes or a subset of accounts associated with the transaction service provider that are associated with the geographic codes. The subset of accounts may include any number of accounts. The subset of accounts may be determined or selected based on any of the information included in the transaction service provider database 110, the issuing institution database 114, and/or the enrollment database 116, as previously described. For example, the subset of accounts may be selected based on desired geographic areas to be classified, desired geographic codes to be classified, association with a particular issuing bank, association or prior transactions with a particular merchant or merchants, association with a particular incentive program, type of account, or any combination thereof. The transaction processing server 102 may, at least in part, determine which of the accounts belong in the subset of accounts. However, it will be appreciated that the determination may be performed by any entity.

With continued reference to FIG. 10, and referring back to FIG. 1, step 5004 may include receiving geographic transaction metrics associated with each geographic code of the plurality of geographic codes from the transaction service provider database 110, the issuing institution database 114, and/or the enrollment database 116. In another example, the transaction processing server 102 may, at least in part, determine or calculate the geographic transaction metrics associated with each geographic code of the plurality of geographic codes based on any of the information included in the transaction service provider database 110, the issuing institution database 114, and/or the enrollment database 116, as previously described, and store the geographic transaction metrics in the transaction service provider database 110. In some examples, the geographic transaction metrics are normalized to a unified scale. For example, the transaction processing server 102 can determine a scaled value for each geographic transaction metric. The scaled value may be determined according to the following Equation (1):

V_{S}=(V_{O}−M_{M})/M_{SD} (1)

wherein V_{S} is the scaled value, V_{O} is the original, unscaled value of the geographic transaction metric, M_{M} is the mean of all values of the geographic transaction metrics, and M_{SD} is the standard deviation of the geographic transaction metric. The receipt, calculation, and/or scaling of the geographic transaction metrics may be performed, at least in part, by the transaction processing server 102. However, it will be appreciated that the receipt, calculation, and/or scaling of the geographic transaction metrics may be performed by any entity.

With continued reference to FIG. 10, and referring back to FIG. 1, step 5006 may include determining, with at least one processor, the optimal number of segments into which the plurality of geographic codes is to be segmented based at least partially on the geographic transaction metrics using the Elbow method. This determination of the optimal number of segments may be performed, at least in part, by the transaction processing server 102. However, it will be appreciated that the determination of the optimal number of segments may be performed by any entity. The Elbow method is a method of interpretation and validation of consistency within cluster/segment analysis designed to help find an appropriate number of clusters or segments in a dataset. The Elbow method analyzes the percentage of variance explained as a function of the number of segments, e.g., the percentage of variance between the geographic transaction metrics of the geographic codes explained or indicated as a function of the number of segments, wherein the optimal number of segments is chosen so that adding another cluster or segment doesn't give significantly better modeling of the data, e.g., does not help to explain or indicate any incremental variance in the data. More precisely, if the percentage of variance explained by the segments is plotted against the number of segments, the first segments add significant information (explains or indicates a larger amount of variance), but at some point the marginal gain drops, giving an angle in the graph. The number of segments is chosen at this point, hence the “elbow criterion”. However, it will be appreciated that the optimal number of segments may be determined using any other method for determining the number of clusters/segments in a data set, such as x-means clustering, information criteria methods, information theoretic methods, the Silhouette methods, cross-validation, and the like.

With continued reference to FIG. 10, and referring back to FIG. 1, step 5008 may include segmenting the plurality of geographic codes into the optimal number of segments of the plurality of geographic codes by applying, with at least one processor, at least one of the following algorithms: k-means clustering, hierarchical clustering, a neural network, a decision tree, or any combination thereof, to the plurality of geographic transaction metrics associated with the plurality of geographic codes. In some non-limiting embodiments or aspects, each geographic code is assigned to only one segment of the optimal number of segments. In other non-limiting embodiments or aspects, there may be overlap in geographic codes in the optimal number of segments. The segmenting may be performed, at least in part, by the transaction processing server 102. However, it will be appreciated that the segmenting may be performed by any entity. For example, the segmenting may include a statistical model, e.g., that uses k-means clustering, to classify geographic codes, e.g., U.S. zip codes, into ‘K’ homogeneous clusters or segments. The geographic transaction metrics, e.g., across discretionary transaction data categories such as airlines, lodging, vehicle rental, retail, etc. and everyday transaction data categories such as gas, grocery, transportation, etc., may be input variables for the model. The model outputs a mapping of U.S. zip codes to U.S. zip clusters or segments that ranges from 0 through ‘K−1’ clusters or segments, with segment transaction metrics associated with each cluster or segment.

Inputs to the k-means clustering are a number of clusters K, which can be determined by the elbow method as described herein, and a data set, which is a collection of features for each data point, i.e., the geographic transaction metrics for each geographic code. The k-means clustering starts with initial estimates for K centroids, which can either be randomly generated or randomly selected from the data set. Each centroid defines one of the K clusters. The algorithm then iterates between two steps: a data assignment step and a centroid update step.

In the data assignment step, each data point, e.g., geographic code, is assigned to its nearest centroid, based on the squared Euclidean distance of its geographic transaction metrics. More formally, if cᵢ is the collection of centroids in set C, then each data point x is assigned to a cluster based on the following Equation (2):

$${arg min}_{{c}_{i} ∈ C} {dist ( {c}_{i} , x )}^{2} \qquad ( 2 )$$

where dist(·) is the standard (L₂) Euclidean distance.

The set of data point assignments for each i^{th} cluster centroid can be Sᵢ. In the centroid update step, the centroids are recomputed by taking the mean of all data points assigned to that centroid's cluster according to the following Equation (3):

$${c}_{i} = \frac{1}{\vert {S}_{i} \vert} {\sum }_{{x}_{i} ∈ {S}_{i}} {x}_{i} \qquad ( 3 )$$

The k-means clustering iterates between the data assignment step and the centroid update step until a stopping criteria is met (e.g., no data points change clusters, the sum of the distances is minimized, or some maximum number of iterations is reached) to find the clusters/segments and data set labels for the optimal number of clusters K.

The segment transaction metrics define, for each segment of the optimal number of segments, proportions of transactions in a plurality of transaction data categories by a subset of accounts of the plurality of accounts associated with that segment. The segment transaction metrics for each segment may be determined, at least in part, by the transaction processing server 102 based on any of the information included in the transaction service provider database 110, the issuing institution database 114, and/or the enrollment database 116, as previously described, including the geographic transaction metrics of the geographic code(s) associated with that segment. The segment transaction metrics can be stored in the transaction service provider database 110. However, it will be appreciated that the segment transaction metrics may be determined by any entity and stored in any database. The segment transaction metrics can include any of the transaction data categories defined herein with respect to the geographic transaction metrics. For example, the segments including the segment transaction metrics associated therewith can serve as a framework for marketing strategies that are designed to target cards that exhibit similar transaction behavior, so that campaigns are more effective and usage and/or conversion is maximized, detect, deter, and/or prevent fraudulent activity in the financial transactions of the accounts, and/or to provide geographic benchmarking of specific locations. However, it will be appreciated that this mapping of geographic codes can be used in any marketing framework or predictive models that require or can benefit from an analysis including a geographic perspective.

With continued reference to FIG. 10, and referring back to FIG. 1, step 5010 may include analyzing, with at least one processor, proportions of transactions in the plurality of transaction data categories by the at least one account of the plurality of accounts with respect to the segment transaction metrics of the at least one segment of the number of segments. A target action may be automatically implemented, with at least one processor, with respect to the at least one account. The at least one account may include a plurality of accounts associated with geographic codes in a same or different segments, each of the accounts in a particular segment, or each of the accounts in a subset of segments of the optimal number of segments. In some examples, the at least one segment of the optimal number of segments may include a geographic code associated with the at least one account. In other examples, the at least one segment of the optimal number of segments does not include a geographic code associated with the at least one account. The at least one segment may include a plurality of segments or each of the segments of the optimal number of segments. The analyzing may be performed, at least in part, by the transaction processing server 102. However, it will be appreciated that the analyzing may be performed by any entity.

In some examples, the target action includes automatically enrolling, with at least one processor, the at least one account in an incentive program. For example, with continued reference to FIG. 10, and referring back to FIG. 1, step 5010 may include the transaction processing server 102 automatically enrolling the at least one account in at least one incentive program by communicating with the enrollment database 116. The incentive program may include any program that provides a benefit to the account holder or user 100 of the account. The benefit may be provided to the account holder or user 100 contingent on past, present, or future use of their portable financial device(s) 103. The benefit may be in the form of a discount, coupon, cash back, promotional item, sweepstakes, or any other incentive to the user 100. The account(s) may be entered into one or multiple incentive programs. The account(s) entered into the incentive program(s) may include the account(s) having one or more proportions of transactions in the plurality of transaction data categories, e.g., as indicated in the transaction service provider database 110, that is relatively different than proportions in those categories indicated by the segment transaction metrics of the at least one segment against which the account(s) is analyzed. For example, proportions of transactions in the plurality of transaction data categories by an account(s) associated with a geographic code located in a first segment may be compared to the segment transaction metrics of the first segment, and if, for example, the percentage of transactions for that account(s) in a particular transaction data category or categories, e.g., a Retail category, is substantially different than the overall percentage of transactions for the first segment in that category or categories, e.g., is a threshold percentage above or below the overall percentage for the first segment in the Retail category, the account(s) may be automatically entered into an incentive program(s) by the transaction processing server 102. For example, an account with substantially lower spending in the Retail category as compared to other accounts associated with geographic codes in the same segment may be automatically enrolled in an incentive program that incentivizes increased retail spending.

In some examples, each account associated with a geographic code of a particular segment or each segment of a subset of the optimal number of segments may be automatically entered into incentive program(s) by the transaction processing server 102. Each account associated with a geographic code of a particular segment or subset of the optimal number of segments may be entered into one or multiple incentive programs. The accounts entered into the incentive program(s) may include those accounts associated with a geographic code of the particular segment or subset of the optimal number of segments having one or more segment transaction metrics that is relatively different than one or more segment transaction metrics of the other or remaining segments of the optimal number of segments. For example, if a segment transaction metric of the particular segment indicates a percentage of transactions in a particular transaction data category, e.g., Dining, that is determined as relatively heavy (or light) spending with respect to the remainder (or some subset) of the optimal number of segments, (e.g., the particular segment may have a relatively higher or lower proportion of spending in a Dining category with respect to the remainder (or some subset) of the optimal number of segments)), the accounts associated with geographic codes in that particular segment may be automatically entered into incentive program(s) by the transaction processing server 102. For example, accounts in a segment with substantially lower spending in the Dining category as compared to an overall total average spending in the Dining category for each of the optimal number of accounts may be automatically enrolled in an incentive program that incentivizes increased dining spending.

With continued reference to FIG. 10, and referring back to FIGS. 1, 2, and 5, step 5010 may include automatically initiating a conversion action to convert at least one account holder or user 100 of the at least one account or particular segment(s) to more frequently use their portable financial device 103, e.g., to more frequently use their portable financial device 103 in for transactions in a particular transaction data category. This conversion action may include automatic enrollment in at least one incentive program as described herein. In some non-limiting embodiments or aspects, automatically enrolling an account(s) in the incentive program may cause a benefit to be transmitted to a computing device 101, such as a mobile device, of the account holder or user 100, such as but not limited to a voucher in an electronic wallet application. In other non-limiting embodiments or aspects, the conversion action may include generating and/or transmitting a communication to a computing device 101 of each account holder or user 100 of the at least one account or particular segment(s). The communication may include information regarding use of their portable financial device 103, including the benefits of using the portable financial device 103. The communication may also include an offer to enter at least one incentive program as described above. This communication may be sent in combination with automatically enrolling the user 100 in an incentive program (e.g., a notification communication notifying the user 100 of enrollment in an incentive program). The communication may be automatically generated and sent to the computing device 101 of the user 100 by the transaction processing server 102. The communication may take any communication form, including a web-based communication, an email communication, a text message, a telephone call, a push notification, and/or an instant message. The communication may be sent to one or multiple account holders. The user 100 may respond to the communication. A conversion action may also include any other action directed to incentivizing, educating, or encouraging a user 100 in the subset to more frequently use their portable financial device 103. The conversion action may be initiated by the conversion action server 117.

With continued reference to FIG. 10, and referring back to FIG. 1, step 5010 may include, when the at least one account includes multiple accounts associated with transactions with a particular merchant system 106 via the geographic codes associated with the multiple accounts, comparing a percentage of the proportions of the plurality of transactions in the plurality of transaction data categories by the multiple accounts that are associated with the particular merchant system 106 to the segment transaction metrics of the at least one segment of the optimal number of segments. For example, the transaction processing server 102 can determine a percentage of market share for the particular merchant system 106 with respect to the at least one segment and/or with respect to at least one other merchant having transactions in geographic codes in the at least one segment. In another example, the transaction processing server 102 can determine differences in market share of the particular merchant system 106 across geographic codes of a particular segment to identify geographic codes in which the merchant's market share is substantially different from its market share in the other geographic codes in that segment, e.g., violates a threshold difference between its market share in an identified geographic code and its market share in the overall segment, to identify specific locations in which the particular merchant is gaining or losing market share and/or in which the merchant can target with advertising, incentive programs, and the like.

With continued reference to FIG. 10, and referring back to FIG. 1, step 5010 may include monitoring the proportions of transactions in the plurality of transaction data categories by the at least one account with respect to the segment transaction metrics of the at least one segment of the optimal number of segments to detect fraudulent activity in the transactions of the at least one account, and the target action may include automatically suspending, with at least one processor and in response to detecting the fraudulent activity, at least one of a transaction activity of the at least one account and access of the at least one account to a system. The transaction processing server 102 can analyze or compare transactions over a past, present, and/or future period of time for a particular account to the segment transaction metrics of at least one segment. For example, the transaction processing server 102 may automatically suspend the activity or access of the particular account based at least partly on a determination that the proportions of transactions for the particular account are significantly different than the segment transaction metrics of the segment in which a geographic code associated with the particular account is located. For example, if a user 100 having a billing zip code in a first segment has transactions over a period of time showing transaction characteristics significantly different than those defined by the segment transaction metrics of the first segment, the transaction processing server 102 can use this information in making a determination of that the account of the user 100 is associated with fraudulent activity and automatically suspend the activity or access of the user 100. A threshold level for determining a substantial difference between a particular account's transaction activity and the segment transaction metrics of a particular segment may be determined by the transaction processing server 102, the issuer server 104, and/or the acquirer server 130 based on any of the information included in the transaction service provider database 110, the issuing institution database 114, and/or the enrollment database 116, as previously described, including the geographic transaction metrics, the segment transaction metrics, or any combination thereof. For example, a substantial difference can be determined based on a standard deviation (or any other statistical measurement of difference) between a particular account's transaction activity and the segment transaction metrics of a particular segment.

In another example, the transaction processing server 102 may automatically suspend the activity or access of the particular account based at least partly on a determination that the proportions of transactions for the particular account are substantially similar to the segment transaction metrics of a segment that does not include a geographic code associated with the particular account. For example, if a user 100 having a billing zip code in a first segment has transactions over a period of time showing transaction characteristics substantially similar to those defined by the segment transaction metrics of a different segment, the transaction processing server 102 can use this information in making a determination that the account of the user 100 is associated with fraudulent activity and automatically suspend the activity or access of the user 100. A threshold level for determining a substantial similarity between a particular account's transaction activity and the segment transaction metrics of a particular segment may be determined by the transaction processing server 102, the issuer server 104, and/or the acquirer server 130 based on any of the information included in the transaction service provider database 110, the issuing institution database 114, and/or the enrollment database 116, as previously described, the geographic transaction metrics, the segment transaction metrics, or any combination thereof. For example, a substantial similarity can be determined based on a standard deviation (or any other statistical measurement of difference) between a particular account's transaction activity and the segment transaction metrics of a particular segment.

With continued reference to FIG. 10, and referring back to FIG. 1, step 5010 may include automatically initiating a fraud deterrence action to suspend, with at least one processor and in response to detecting fraudulent activity, at least one of a transaction activity of the account of the user 100 and access of the account of the user 100 to a system. For example, the transaction processing server 102 may cancel a current transaction being attempted by the account, void one or more previous transactions completed by the account, prevent all future transactions attempted by the account, prevent or cancel transactions of the account at specific merchants, (e.g., merchants at which the card was not used prior to determination of the fraudulent activity), prevent or cancel transactions of the account at merchants associated with specific geographic codes, prevent future transactions attempted by the account for a predetermined period of time, and the like. The transaction processing server 102 may automatically suspend access of the user 100 and/or a third party to an otherwise accessible online portal or management website for the account or to certain subsystems of the online portal or management website, such as subsystems providing user information and/or account information.

In other non-limiting embodiments or aspects, the fraud deterrence action may include automatically generating and/or transmitting a communication to a computing device 101 of the account holder or user 100 indicating that fraudulent activity has been detected. The communication may include an electronic link, such as a URL, embedded script, or application, that causes the computing device 101 of the user 100 to automatically access, at the transaction processing server 102, issuer server 104, acquirer server 130, merchant system 106, or any combination thereof, information related to the fraudulent activity when the user 100 opens or accesses the communication on their device. For example, the communication may provide an indication that fraudulent activity been detected with an option for the user to receive more information about the activity, such as, times, dates, types of transactions, amounts of transactions, merchants at which the transactions were conducted, reasons for the determination as fraud, and the like. The communication may provide the user 100 with an option to flag in a system of the transaction processing server 102, issuer server 104, and/or acquirer server 130 via their computing device 101 specific transactions as fraudulent or not via the electronic links and/or an option to be automatically connected to a fraud representative at the transaction service provider, the issuing institution, and/or acquirer. The fraud deterrence action may be initiated by the fraud deterrence server 117.

With continued reference to FIG. 10, and referring back to FIGS. 4-9, in some non-limiting embodiments or aspects, step 5010, as described above, may instead or additionally be performed by the issuer server 104 and/or the acquirer server 130. The issuer server 104 and/or the acquirer server 130 may be in communication with the transaction processing server 102 to receive information from the transaction processing server 102, such as metrics for individual account holders, the geographic transaction metrics, the optimal number of segments, and/or the segment transaction metrics. The issuer server 104 and/or the acquirer server 130, from the information received from the transaction processing server 102, may initiate the previously described conversion action or fraud deterrence action. In other words, the issuer server 104 and/or the acquirer server 130 may automatically enroll the at least one account in an incentive program by communicating with the enrollment database 120, or automatically monitor the proportions of transactions in the plurality of transaction data categories by the at least one account with respect to the segment transaction metrics of the at least one segment of the optimal number of segments to detect fraudulent activity in the transactions of the at least one account, and automatically suspend, in response to detecting the fraudulent activity, at least one of a transaction activity of the at least one account and access of the at least one account to a system, e.g., an online portal or management website for the account at the issuer server 104.

In other non-limiting examples, the issuer server 104 and/or the acquirer server 130 may communicate with a computing device 101 of the user 100, as described above. Further, it will be appreciated that the issuer server 104 and/or the acquirer server 130 may take any other action directed to incentivizing, educating, or encouraging a user 100 to more frequently use their portable financial device, as described above, to detect fraudulent activity in the financial transactions of the accounts, and/or provide geographic benchmarking of specific locations. The issuer server 104 and/or the acquirer server 130 may communicate with the conversion action/fraud deterrence server 117 to institute the conversion action or the fraud deterrence action. It is to be understood that the transaction processing server 102, the issuer server 104, and/or the acquirer server 130 may automatically initiate the conversion action(s) and/or the fraud deterrence action(s). The transaction processing server 102, the issuer server 104, and/or the acquirer server 130 may communicate with the conversion action/fraud deterrence server 117 to initiate the conversion action or fraud deterrence action.

In a further, non-limiting embodiment or aspect, a computer program product for segmenting geographic codes in a behavior-monitored system including a plurality of accounts includes at least one non-transitory computer readable medium including program instructions that, when executed by at least one processor, cause the at least one processor to execute the previously-described method (e.g., method 5000). The at least one processor may include the transaction processing server 102, the issuer server 104, the acquirer server 130, and/or the conversion/fraud deterrence action processor 117.

The computer program product may include a plurality of computer-readable media, such as a first computer-readable medium and a second compute readable medium. The first computer-readable medium may be located at the transaction processing server 102. The second computer-readable medium may be located remote from the transaction processing server 102, such as at the issuer server 104 and/or the acquirer server 130.

### Examples

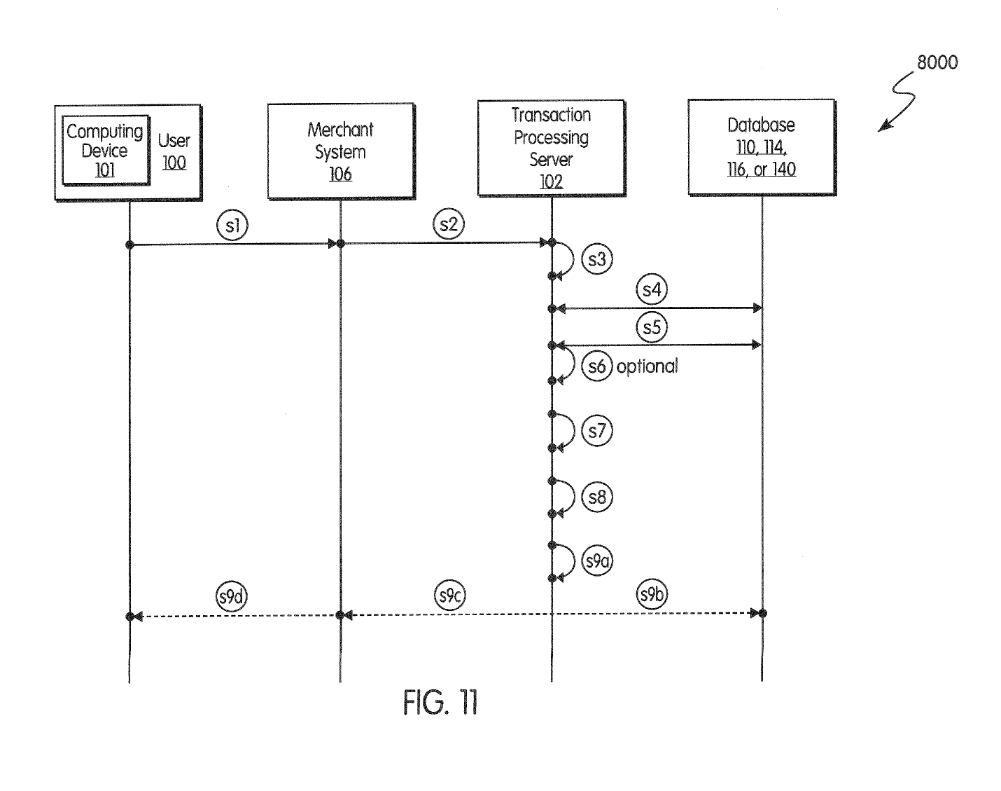

Referring to FIG. 11, a process flow diagram shows an exemplary process 8000 for segmenting geographic codes in a behavior-monitored system including a plurality of accounts. It will be appreciated that the steps shown in the process flow diagram are for exemplary purposes only and that in various non-limiting embodiments or aspects, additional or fewer steps maybe performed to segment geographic codes. At a first step (s1), a user 100 initiates and completes a financial transaction using a portable financial device 103 associated with the transaction service provider. The transaction may be a financial transaction with a merchant system 106 having a merchant POS 108, as an example. In the case of a financial transaction with a merchant system 106 having a merchant POS 108, the user 100 provides information from his/her personal financial device 103, such as an account identifier (e.g., 16-digit PAN) and, in some examples, a geographic code (e.g., a billing zip code), to complete a financial transaction in exchange for goods or services offered by the merchant system 106. The merchant POS 108, in response, processes the transaction. At a second step (s2), the merchant system 106, through the merchant POS 108, sends transaction data concerning the financial transaction between the merchant system 106 and the user 100 to the transaction processing server 102. Information sent to the transaction processing server 102 may include: date and time of the transaction, location of the transaction including a geographic code of the merchant and/or a geographic code associated with the account of the user 100, amount of the transaction, type of goods or services purchased, and/or the like. At a third step (s3), the transaction processing server 102 relays the information collected regarding the user's transactions to a transaction service provider database 110 owned and/or controlled by or on behalf of the transaction service provider. The first through third steps of FIG. 8 (s1-s3) may be performed for any number of transactions for a particular user 100 and may be performed for all transactions by any number of users who are account holders of the transaction service provider.

With continued reference to FIG. 11, in a fourth step (s4), the transaction processing server 102 identifies a portfolio of accounts or financial transaction devices for which the geographic codes associated therewith, e.g., the billing U.S. zip codes of the accounts, the financial transaction service provider wants to be classified. The transaction processing server 102 may identify the accounts and associated U.S. zip codes in the transaction service provider database 110.

At a fifth step (s5), the transaction processing server 102 receives geographic transaction metrics associated with each identified U.S. zip code from the transaction service provider database 110. In another example, at an optional sixth step (s6), the transaction processing server 102 can determine or calculate the geographic transaction metrics for each identified U.S. zip code based on the information provided retrieved from the transaction service provider database 110.

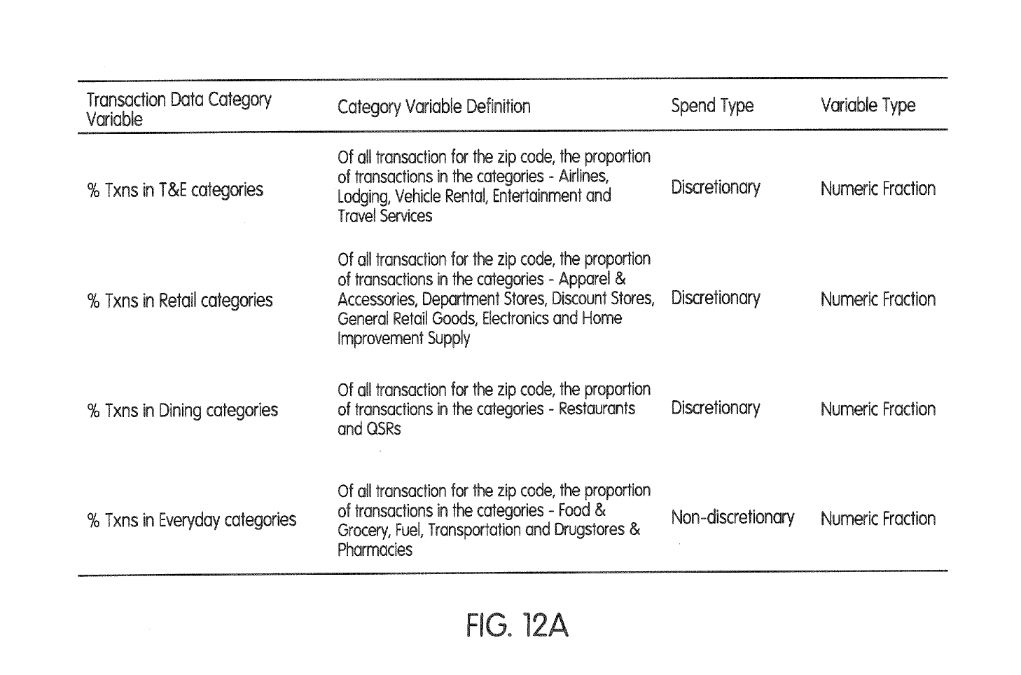

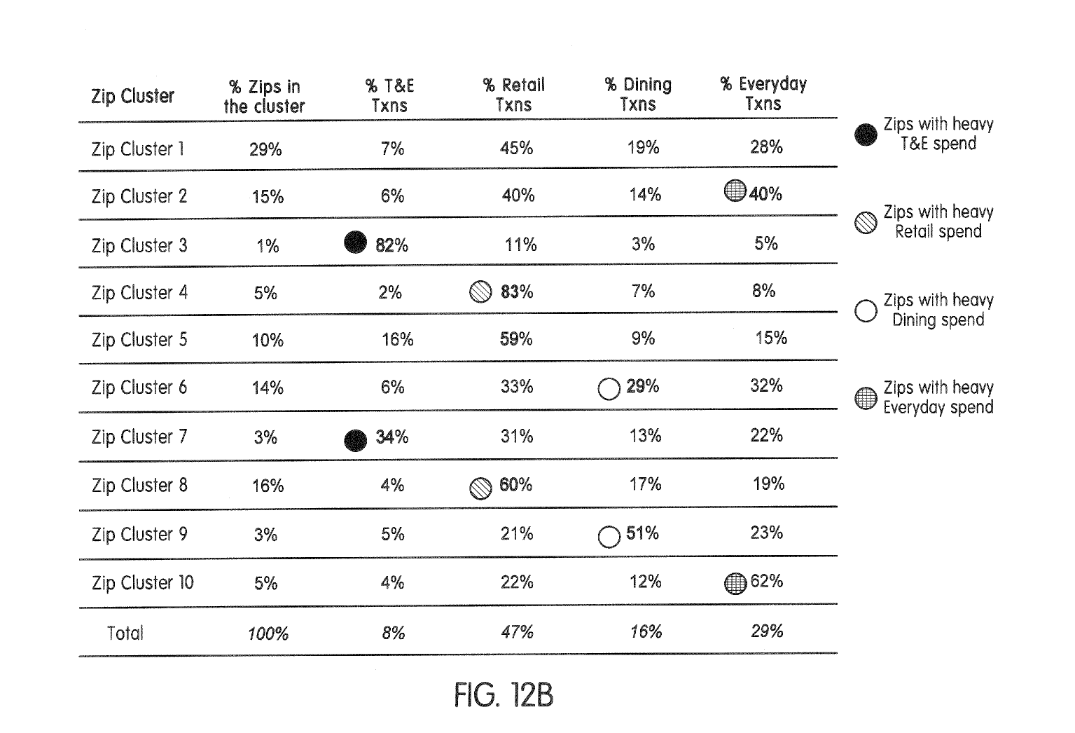

The geographic transaction metrics define, for each U.S. zip code, proportions of transactions in a plurality of transaction data categories by a subset of accounts of the plurality of accounts associated with that U.S. zip code. The plurality of transaction data categories used to determine the geographic transaction metrics may be selected by the transaction service provider as the categories most relevant to more efficiently determine users or accounts more likely to be receptive to specific messages and incentives regarding use or increased use of their portable financial devices, to detect, deter, and/or prevent fraudulent activity in the financial transactions of the accounts, and/or to provide geographic benchmarking of specific locations. In other examples, the determination of the transaction data categories may be determined by the transaction processing server 102. In some non-limiting embodiments or aspects, the transaction data categories used to determine the geographic transaction metrics for each U.S. zip code includes those transaction data categories shown in the table in FIG. 12A.

For example, the transaction data categories used to determine the geographic transaction metrics in this example include: a proportion or percentage of transactions for the U.S. zip code in a Travel and Entertainment category including transactions related to airlines, lodging, vehicle rental, entertainment and travel services, and the like; a proportion or percentage of transactions for the U.S. zip code in a Retail category including transactions related to apparel and accessories, department stores, discount stores, general retail goods, electronics and home improvement stores, and the like; a proportion or percentage of transactions for the U.S. zip code in a Dining category including transactions related to restaurants and quick service restaurants, and the like; and a proportion or percentage of transactions for the U.S. zip code in an Everyday spending category including transactions related to food and groceries, fuel, transportation, drugstores and pharmacies, and the like. Everyday transactions may be defined as non-discretionary spending, whereas transactions in the other categories in FIG. 12A may be defined as discretionary spending.

With continued reference to FIG. 11, at a seventh step (s7), the transaction processing server 102 determines an optimal number of segments into which the U.S. zip codes are to be segmented based at least partially on the geographic transaction metrics. For example, the transaction processing server 102 can apply the Elbow method to geographic transaction metrics of the U.S. zip codes to determine the optimal number of segments. At an eighth step (s8), the transaction processing server 102 segments the U.S. zip codes into the optimal number of segments based at least partially on the geographic transaction metrics, such that each segment is associated with segment transaction metrics. For example, the transaction processing server 102 may apply k-means clustering to the geographic transaction metrics of the U.S. zip codes to segment the U.S. zip codes into ‘K’ homogenous segments. As previously noted, the segment transaction metrics define, for each segment of the optimal number of segments, proportions of transactions in a plurality of transaction data categories by a subset of accounts of the plurality of accounts associated with that segment.

In some non-limiting embodiments or aspects, for example, if the transaction data categories used to determine the geographic transaction metrics for each U.S. zip code include those transaction data categories shown in the table in FIG. 12A, the segment transaction metrics may be based on the same transaction data categories used to determine the geographic transaction metrics as shown in the table in FIG. 12B. For example, the segment transaction metrics for each segment (cluster) of the optimal number of segments (10 in the example of FIG. 12B) may define for each segment a proportion or percentage of the total number of segmented U.S. zip codes in that segment, (e.g., zip segment/cluster 1 includes 29% of the U.S. zip codes applied to the k-means clustering in the example of FIG. 12B) and proportions or percentages of transactions in the U.S. zip codes in that segment in the plurality of categories (e.g., zip segment/cluster 1 has segment transaction metrics indicating 7% of its transactions in the Travel and Entertainment category, 45% of its transaction in the Retail category, 19% of its transactions in the Dining Category, and 28% of its transactions in the Everyday category in the example of FIG. 12B). The transaction processing server 102 can identify particular transaction data categories in specific segments as having relatively heavy (or light) spending than other segments in the same category. For example, as shown in the example of FIG. 12B, zip cluster/segment 4 and zip cluster/segment 8 are identified as having heavy spend in the Retail transaction data category as compared to the other clusters/segments. A segment may be identified as having heavy (or light) spend if its percentage of transactions in a particular category is greater (or less) than a threshold percentage, for example, if its percentage of transactions in a particular category is greater (or less) than an average percentage for all segments across the particular category.

With continued reference to FIG. 11, at a ninth step (s9a-s9d), the transaction processing server 102 automatically initiates a target action with respect to at least one account of the plurality of accounts based at least partially on the segment transaction metrics corresponding to at least one segment of the optimal number of segments determined in the eighth step (s8). As previously described, a target action may include a conversion action or a fraud deterrence action. For example, a conversion action may be performed by the transaction processing server 102 to automatically enroll the at least one account in at least one incentive program (s9a). The conversion action may be performed by the transaction processing server 102 to automatically update information associated with the at least one account in the database 110, 114, 116, and/or 140 (s9b) to indicate that the account is enrolled in the at least one incentive program and/or update. The conversion action may be performed by the conversion action server 117 and/or transaction processing server 102 by automatically transmitting the at least one account to the merchant system 106 (s9c) to incentivize, educate, or encourage a user 100 of the at least one account to more frequently use their portable financial device. The conversion action may be performed by the transaction processing server 102 and/or the conversion action server 117 by automatically transmitting a communication to a computing device 101 of the user 100 of the at least one account (s9d) to incentivize, educate, or encourage a user 100 of the at least one account to more frequently use their portable financial device.

In another example, a fraud deterrence action may be performed by the transaction processing server 102 to automatically suspend, in response to detecting the fraudulent activity, at least one of a transaction activity of the at least one account and access of the at least one account to a system in step (s9a). The fraud deterrence action may be performed by the transaction processing server 102 to automatically transmit information associated with the at least one account to the database 110, 114,116, and 140 (s9b) to flag the account as associated with fraudulent activity and/or to suspend a transaction activity and/or access of the at least one account to the transaction processing server 102 or a subsystem thereof. The fraud deterrence action may be performed by the fraud deterrence server 117 and/or the transaction processing server 102 by automatically transmitting the at least one account to the merchant system 106 (s9c) to notify the merchant that the at least one account is now associated with fraudulent activity and/or to cancel a transaction attempted with the merchant system 106 by the at least one account. The fraud deterrence action may be performed by the transaction processing server 102 and/or the conversion action server 117 by automatically transmitting a communication to a computing device 101 the user 100 of the at least one account (s9d).

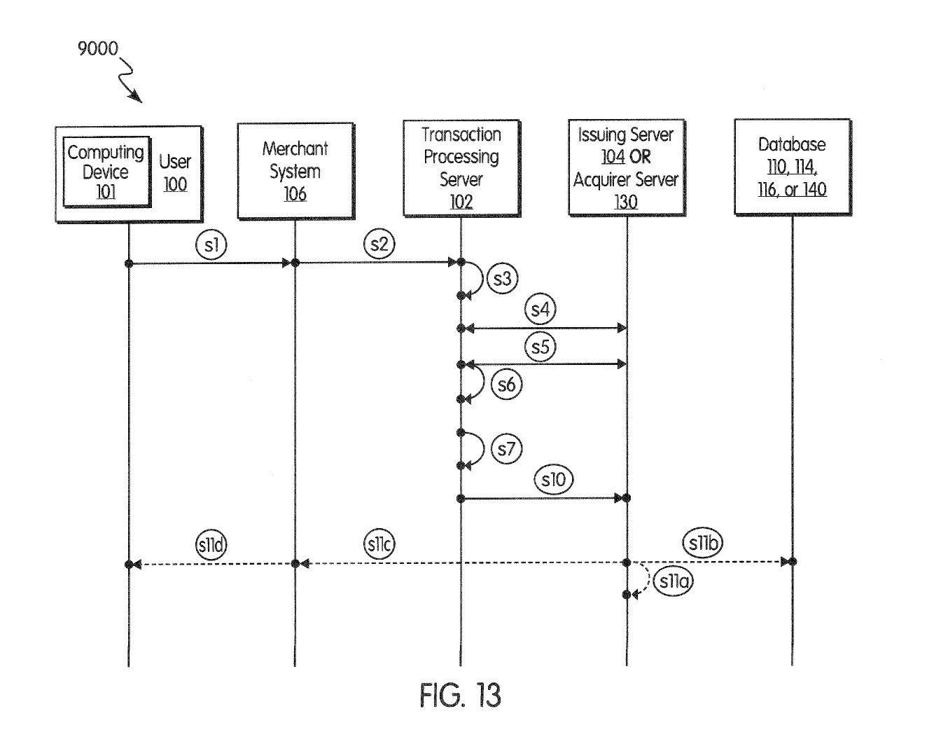

Referring to FIG. 13 a process flow diagram shows an exemplary process 9000 for segmenting geographic codes in a behavior-monitored system including a plurality of accounts. The first step through the eight steps (s1-s8) are identical to the exemplary process 8000 described above and illustrated in FIG. 8. Following the eighth step in the exemplary process 9000 of FIG. 11, a tenth step (s10) is performed. At the tenth step (s10) the transaction processing server 102 provides the issuer server 104 or the acquirer server 130 the optimal number of segments associated with the segment transaction metrics.

With continued reference to FIG. 13, at an eleventh step (s11a-s11d), the issuer server 104 or acquirer server 130 automatically initiates a target action with respect to at least one account of the plurality of accounts based at least partially on the segment transaction metrics corresponding to at least one segment of the optimal number of segments determined in the eighth step (s8). As previously described, a target action may include a conversion action or a fraud deterrence action. For example, a conversion action may be performed by the issuer server 104 or the acquirer server 130 (and/or the conversion action server 117) to automatically enroll at least one account in at least one incentive program (s11a). The conversion action may be performed by the issuer server 104 or the acquirer server 130 (and/or the conversion action server 117 to automatically update information associated with the at least one account to the database 110, 114, 116, and/or 140 (s11b). The conversion action may be performed by the issuer server 104 or the acquirer server 130 (and/or the conversion action server 117) by automatically transmitting the at least one account to the merchant system 106 (s11c) to incentivize, educate, or encourage a user 100 of the at least one account to more frequently use their portable financial device. The conversion action may be performed by the issuer server 104 or the acquirer server 130 (and/or the conversion action server 117) by automatically transmitting a communication to a computing device 101 of the user 100 of the at least one account (s11d) to incentivize, educate, or encourage a user 100 of the at least one account to more frequently use their portable financial device.

In another example, a fraud deterrence action may be performed by the issuer server 104 or the acquirer server 130 (and/or the fraud deterrence server 117) to automatically suspend, in response to detecting the fraudulent activity, at least one of a transaction activity of the at least one account and access of the at least one account to a system in step (s11a). The fraud deterrence action may be performed by the issuer server 104 or the acquirer server 130 (and/or the fraud deterrence server 117) to automatically transmit information associated with the at least one account to the database 110, 114, 116, and 140 (s11b) to flag the account as associated with fraudulent activity and/or to suspend, within the issuer server 104 or acquirer server 130 a transaction activity and/or access of the at least one account to the issuer server 104 or acquirer server 130 (or a subsystem thereof). The fraud deterrence action may be performed by the issuer server 104 or the acquirer server 130 (and/or the fraud deterrence processor 117) by automatically transmitting the at least one account to the merchant system 106 (s11c) to notify the merchant that the at least one account is now associated with fraudulent activity and/or to cancel a transaction attempted with the merchant system 106 by the at least one account. The fraud deterrence action may be performed by the issuer server 104 or the acquirer server 130 (and/or the fraud deterrence processor 117) by automatically transmitting a communication to a computing device 101 of the user 100 of the at least one account (s11d).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

The invention claimed is:

1. A computer-implemented method for segmenting geographic codes in a behavior-monitored system including a plurality of accounts, comprising:
identifying, with at least one processor, a plurality of geographic codes associated with the plurality of accounts, wherein each account of the plurality of accounts is associated with a geographic code of the plurality of geographic codes;
receiving, with at least one processor, geographic transaction metrics associated with each geographic code of the plurality of geographic codes;
determining, with at least one processor, an optimal number of segments into which the plurality of geographic codes is to be segmented based at least partially on the geographic transaction metrics;
segmenting, with at least one processor, the plurality of geographic codes into the optimal number of segments based at least partially on the geographic transaction metrics, such that each segment is associated with segment transaction metrics; and
automatically implementing, with at least one processor, a target action with respect to at least one account of the plurality of accounts based at least partially on the segment transaction metrics corresponding to at least one segment of the optimal number of segments.

2. The method of claim 1, wherein the geographic transaction metrics define, for each geographic code of the plurality of geographic codes, proportions of transactions in a plurality of categories by a subset of accounts of the plurality of accounts associated with that geographic code, and wherein the segment transaction metrics define, for each segment of the optimal number of segments, proportions of transactions in the plurality of categories by a subset of accounts of the plurality of accounts associated with that segment.

3. The method of claim 2, wherein the plurality of categories comprises at least two of the following: travel and entertainment transactions, retail transactions, dining transactions, everyday spending transactions, or any combination thereof.

4. The method of claim 2, further comprising monitoring, with at least one processor, proportions of transactions in the plurality of categories by the at least one account of the plurality of accounts with respect to the segment transaction metrics of the at least one segment of the optimal number of segments to detect fraudulent activity in the transactions of the at least one account, and wherein the target action comprises automatically suspending, with at least one processor and in response to detecting the fraudulent activity, at least one of a transaction activity of the at least one account and access of the at least one account to a system.

5. The method of claim 1, wherein the target action comprises automatically enrolling, with at least one processor, the at least one account in an incentive program.

6. The method of claim 1, wherein the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

7. The method of claim 1, further comprising normalizing, with at least one processor, the plurality of geographic transaction metrics to a unified scale, wherein the unified scale is determined according to the following equation:
VS=(VO−MM)/MSD
wherein VS is the scaled value of a geographic transaction metric, VO is the original, unscaled value of the geographic transaction metric, MM is the mean of all values of the geographic transaction metrics, and MSD is the standard deviation of the geographic transaction metric.

8. The method of claim 1, wherein segmenting the plurality of geographic codes into the optimal number of segments of the plurality of geographic codes comprises applying, with at least one processor, at least one of the following algorithms: k-means clustering, hierarchical clustering, a neural network, a decision tree, or any combination thereof, to the plurality of geographic transaction metrics associated with the plurality of geographic codes.

9. The method of claim 8, wherein segmenting the plurality of geographic codes into the optimal number of segments of the plurality of geographic codes comprises applying, with at least one processor, k-means clustering, the method further comprising:
determining centroids of the optimal number of segments; and
iterating between a data assignment step and a centroid update step until a stopping criteria is met, wherein the data assignment step comprises:
assigning each geographic code to a segment of the optimal number of segments according to the following equation:
$${arg min}_{{c}_{i} ∈ C} {dist ( {c}_{i} , x )}^{2}$$
wherein i is the optimal number of segments, C is a set of centroids cᵢ including the centroids of the optimal number of segments, x is a geographic code of the plurality of geographic codes, and dist(·) is the standard (L₂) Euclidean distance between the geographic code x and the centroids cᵢ;
wherein the centroid update step comprises:
recalculating the centroids of the optimal number of segments according to the following equation:
$${c}_{i} = \frac{1}{\vert {S}_{i} \vert} {\sum }_{{x}_{i} ∈ {S}_{i}} {x}_{i}$$
wherein Sᵢ is set of geographic code assignments for each i^{th} segment centroid.

10. A system for segmenting geographic codes in a behavior-monitored system including a plurality of accounts, comprising at least one server computer including at least one processor, the at least one server computer programmed and/or configured to:
identify a plurality of geographic codes associated with the plurality of accounts, wherein each account of the plurality of accounts is associated with a geographic code of the plurality of geographic codes;
receive geographic transaction metrics associated with each geographic code of the plurality of geographic codes;
determine an optimal number of segments into which the plurality of geographic codes is to be segmented based at least partially on the geographic transaction metrics;
segment the plurality of geographic codes into the optimal number of segments based at least partially on the geographic transaction metrics, such that each segment is associated with segment transaction metrics; and
automatically implement a target action with respect to at least one account of the plurality of accounts based at least partially on the segment transaction metrics corresponding to at least one segment of the optimal number of segments.

11. The system of claim 10, wherein the geographic transaction metrics define, for each geographic code of the plurality of geographic codes, proportions of transactions in a plurality of categories by a subset of accounts of the plurality of accounts associated with that geographic code, and wherein the segment transaction metrics define, for each segment of the optimal number of segments, proportions of transactions in a plurality of categories by a subset of accounts of the plurality of accounts associated with that segment.

12. The system of claim 11, wherein the plurality of categories comprises at least two of the following: travel and entertainment transactions, retail transactions, dining transactions, everyday spending transactions, or any combination thereof.

13. The system of claim 11, wherein the at least one server computer is programmed and/or configured to:
monitor proportions of transactions in the plurality of categories by the at least one account of the plurality of accounts with respect to the segment transaction metrics of the at least one segment of the optimal number of segments to detect fraudulent activity in the transactions of the at least one account; and
automatically implement the target action by automatically suspending, in response to detecting the fraudulent activity, at least one of a transaction activity of the at least one account and access of the at least one account to a system.

14. The system of claim 10, wherein the at least one server computer is programmed and/or configured to:
automatically implement the target action by automatically enrolling the at least one account in an incentive program.

15. The system of claim 10, wherein the optimal number of segments into which the plurality of geographic codes is to be segmented is identified based on an elbow method, wherein the elbow method determines a percentage of variance between the geographic transaction metrics of the plurality of geographic codes as a function of the number of optimal segments, and wherein the optimal number of segments is identified in response to a determination that adding an additional segment to the optimal number of segments does not indicate an incremental variance in the geographic transaction metrics of the plurality of geographic codes.

16. The system of claim 10, wherein the at least one server computer is programmed and/or configured to:
normalize the plurality of geographic transaction metrics to a unified scale, wherein the unified scale is determined according to the following equation:
VS=(VO−MM)/MSD
wherein VS is the scaled value of a geographic transaction metric, VO is the original, unscaled value of the geographic transaction metric, MM is the mean of all values of the geographic transaction metrics, and MSD is the standard deviation of the geographic transaction metric.

17. The system of claim 10, wherein the at least one server computer is programmed and/or configured to segment the plurality of geographic codes into the optimal number of segments of the plurality of geographic codes by applying at least one of the following algorithms: k-means clustering, hierarchical clustering, a neural network, a decision tree, or any combination thereof, to the plurality of geographic transaction metrics associated with the plurality of geographic codes.

18. The system of claim 17, wherein the at least one server computer is programmed and/or configured to segment the plurality of geographic codes into the optimal number of segments by applying k-means clustering, t wherein the at least one server computer is programmed and/or configured to:
determine centroids of the optimal number of segments; and
iterate between a data assignment step and a centroid update step until a stopping criteria is met, wherein the data assignment step comprises:
assigning each geographic code to a segment of the optimal number of segments according to the following equation:
$${arg min}_{{c}_{i} ∈ C} {dist ( {c}_{i} , x )}^{2}$$
wherein i is the optimal number of segments, C is a set of centroids cᵢ including the centroids of the optimal number of segments, x is a geographic code of the plurality of geographic codes, and dist(·) is the standard (L₂) Euclidean distance between the geographic code x and the centroids cᵢ;
wherein the centroid update step comprises:
recalculating the centroids of the optimal number of segments according to the following equation:
$${c}_{i} = \frac{1}{\vert {S}_{i} \vert} {\sum }_{{x}_{i} ∈ {S}_{i}} {x}_{i}$$
wherein Sᵢ is set of geographic code assignments for each i^{th} segment centroid.

19. A computer program product for segmenting geographic codes in a behavior-monitored system including a plurality of accounts, comprising at least one non-transitory computer-readable medium including program instructions that, when executed by at least one processor cause the at least one processor to:
identify a plurality of geographic codes associated with the plurality of accounts, wherein each account of the plurality of accounts is associated with a geographic code of the plurality of geographic codes;
receive geographic transaction metrics associated with each geographic code of the plurality of geographic codes;
determine an optimal number of segments into which the plurality of geographic codes is to be segmented based at least partially on the geographic transaction metrics;
segment the plurality of geographic codes into the optimal number of segments based at least partially on the geographic transaction metrics, such that each segment is associated with segment transaction metrics; and
automatically implement a target action with respect to at least one account of the plurality of accounts based at least partially on the segment transaction metrics corresponding to at least one segment of the optimal number of segments.

20. The computer program product of claim 19, wherein the geographic transaction metrics define, for each geographic code of the plurality of geographic codes, proportions of transactions in a plurality of categories by a subset of accounts of the plurality of accounts associated with that geographic code, and wherein the segment transaction metrics define, for each segment of the optimal number of segments, proportions of transactions in the plurality of categories by a subset of accounts of the plurality of accounts associated with that segment.
